(19) United States
(12) Patent Application Publication
(10) Pub. No.: US 2026/0182815 A1
(43) Pub. Date: Jul. 2, 2026

(54) DISHWASHER

(71) Applicant: LG Electronics Inc., Seoul (KR)

(72) Inventors: Yeon A JO, Seoul (KR); Dong Jun CHOI, Seoul (KR); Yongnam KIM, Seoul (KR); Sangwoog CHO, Seoul (KR); Min Kyu OH, Seoul (KR); Sung Hyun PARK, Seoul (KR); Jin Won KANG, Seoul (KR)

(21) Appl. No.: 19/436,120

(22) Filed: Dec. 30, 2025

(30) Foreign Application Priority Data
Dec. 30, 2024 (KR) 10-2024-0199774
May 21, 2025 (KR) 10-2025-0066109

(51) Int. Cl. A47L 15/42; E05B 5/02; F21V 23/04; F21V 33/00; F21Y 105/16; F21Y 115/10; H05B 45/28

(52) U.S. Cl. CPC A47L 15/4257; E05B 5/003; F21V 23/0471; F21V 23/0485; F21V 33/0044; H05B 45/28; A47L 2301/08; F21V 2200/15; F21Y 2105/16; F21Y 2115/10

(57) ABSTRACT

A dishwasher includes a tub having a washing space defined therein and configured to accommodate therein a dish, a door configured to open or close the washing space of the tub, and a handle movably disposed in the door and configured to extend outwardly from the door or retract into the door. The handle is configured to extend outwardly from the door to a first position or a second position, where a distance between the second position and the door is greater than a distance between the first position and the door.

### CROSS-REFERENCE TO RELATED APPLICATIONS

This application claims priority from Korean Patent Application No. 10-2024-0199774, filed on Dec. 30, 2024, and Korean Patent Application No. 10-2025-0066109, filed on May 21, 2025, in the Korean Intellectual Property Office, which are hereby incorporated by reference in their entirety.

### BACKGROUND

### Field

The present disclosure relates to a dishwasher, and more particularly, to a dishwasher having a handle automatically extending from a door, and a control method thereof.

### Description of Related Art

A dishwasher is a device for washing dishes, cooking utensils, etc. as objects to be washed, that is, washing targets as stored therein, by spraying washing water such as water thereto.

In general, the dishwasher is configured to perform a washing cycle of washing the washing target, a rinsing cycle of rinsing the washing target, and a drying cycle of drying the washed and rinsed washing target.

Such a dishwasher may be provided with a handle installed in a door and capable being gripped by a user.

### SUMMARY

A purpose to be achieved by the present disclosure is to provide a dishwasher in which a handle automatically extends outwardly from a door.

In addition, a purpose to be achieved by the present disclosure is to provide a dishwasher capable of turning on a light source module of a handle to act as a welcome lighting.

In addition, a purpose to be achieved by the present disclosure is to provide a dishwasher in which a handle may serve as a safety sensor.

In addition, a purpose to be achieved by the present disclosure is to provide a dishwasher in which a handle is used as a means for performing a user interface (UI) function.

In addition, a purpose to be achieved by the present disclosure is to provide a dishwasher in which a handle is hidden in a door and then extends outwardly from the door only when necessary, thereby maintaining a seamless face design.

In addition, a purpose to be achieved by the present disclosure is to provide a dishwasher capable of notifying a state of each operation situation of the dishwasher through a light source module of a handle.

The purposes to be solved according to an embodiment of the present disclosure are not limited to the above-mentioned purposes, and other purposes not mentioned will be clearly understood by those skilled in the art from the following description.

In the dishwasher according to an embodiment of the present disclosure, the handle may be automatically withdrawn or extend outwardly from the door.

Specifically, the dishwasher may include a handle movably disposed in the door and configured to extend outwardly from the door or retract into the door, wherein the handle is configured to extend outwardly from the door to a first position or a second position, wherein a distance between the second position and the door is greater than a distance between the first position and the door.

In addition, the dishwasher according to an embodiment of the present disclosure may perform welcome lighting using the light source module of the handle. Specifically, when a person is detected, the dishwasher may move the handle to the first position at which light emitted from the light source module is exposed to the outside and the light source module may perform preset welcome lighting.

In addition, in the dishwasher according to an embodiment of the present disclosure, the handle may serve as a safety sensor. Specifically, in response to that the handle is caught into between the handle and the door while the handle is moving from the second position to the first position, the dishwasher may move the handle to the second position and flicker the light source module in a red color.

In addition, the dishwasher according to an embodiment of the present disclosure may be used as a means for performing the UI function. Specifically, the dishwasher may be configured to perform a preset UI function based on a touch position on the handle by the hand or a touch pattern of the hand on the handle.

In addition, the dishwasher according to an embodiment of the present disclosure may retract the handle into the door so as to be hidden in the door and then extend the handle outwardly from the door only when necessary, thereby maintaining a seamless face design. Specifically, in response to that the human hand is not detected within a predetermined time duration after the human has been detected, the dishwasher may operate in a default mode in which the handle is hidden in the door. In addition, in response to that a preset touch input is sensed after the person is sensed, the dishwasher may operate the handle in the default mode.

In addition, the dishwasher according to an embodiment of the present disclosure may inform the state of each operation situation of the dishwasher through the light source module of the handle. Specifically, the light source module of the handle of the dishwasher may be turned on at the color varying based on each cycle situation of the dishwasher operation mode.

In addition, in response to that the handle is caught into between the door and the handle, the dishwasher according to an embodiment of the present disclosure may flicker the light source module in a red color to notify the user of the handing pinching.

In addition, in response to that the human hand is sensed on the handle in the dishwasher operation mode, the dishwasher may extend the handle to the second position, and turn on the light source module in a color corresponding to the inside temperature of the dishwasher.

As described above, the dishwasher of the present disclosure includes the handle movable so as to extend outwardly from the door, wherein the handle may extend to the first position or the second position, wherein a distance between the second position and the door is greater than a distance between the first position and the door.

In addition, the dishwasher of the present disclosure may move the handle to the first position at which light emitted from the light source module is exposed to the outside and the light source module may perform the preset welcome lighting.

In addition, in response to that the handle is caught into between the handle and the door while the handle is moving from the second position to the first position, the dishwasher of the present disclosure may move the handle to the second position and flicker the light source module in a red color, such that the handle may function as a safety sensor.

In addition, the dishwasher of the present disclosure is configured to perform a preset UI function according to a sensed touch position or touch pattern of the handle, and thus the handle may be used as a means for performing the UI function.

In addition, in response to that the human hand is not sensed within a predetermined time duration after the person has been sensed, the dishwasher of the present disclosure operates the handle in the default mode in which the handle is hidden in the front panel of the door, thereby allowing the handle to extend only when necessary and maintaining a seamless face design.

In addition, in response to that a preset touch input is sensed after the person has been sensed, the dishwasher of the present disclosure operates the handle in a default mode, thereby allowing the handle to extend only in necessary situations and maintaining a seamless face design.

In addition, the dishwasher of the present disclosure may turn on the light source module such that the color of the light varies according to the cycle state of the dishwasher operating mode, thereby informing the operating state of the dishwasher through the light source module of the handle.

In addition, in response to that the hand is caught into the handle and the door, the dishwasher of the present disclosure may flicker the light source module of the handle in a red color to notify the user of the hand pinching.

In addition, in response to that the human hand is sensed in the dishwasher operation mode, the dishwasher of the present disclosure may extend the handle to the second position, and turn one the light source module in a color corresponding to the inside temperature of the dishwasher 1 to notify the user of the temperature related situation.

The effects of the present disclosure are not limited to the above-mentioned effects, and other effects not mentioned will be clearly understood by those skilled in the art from the following descriptions.

### BRIEF DESCRIPTION OF DRAWINGS

FIG. 1 is a front perspective view of a dishwasher according to an embodiment o the present disclosure.

FIG. 2 is a schematic cross-sectional view of the dishwasher as shown in FIG. 1.

FIG. 3 is a diagram illustrating a state in which a handle of a dishwasher according to an embodiment of the present disclosure is hidden inside a door.

FIG. 4 is a diagram illustrating a state in which a handle of a dishwasher according to an embodiment of the present disclosure has maximally extended.

FIG. 5 is a side view illustrating a state in which the handle as illustrated in FIG. 4 has maximally extended.

FIG. 6 is a side view illustrating a state in which a handle of a dishwasher according to an embodiment of the present disclosure has partially extended.

FIG. 7 is an exploded perspective view of a handle of a dishwasher according to an embodiment of the present disclosure.

FIG. 8 is an enlarged perspective view of a handle of a dishwasher according to an embodiment of the present disclosure.

FIG. 9 is a side cross-sectional view of the handle of FIG. 8.

FIG. 10 is a diagram illustrating a position of a first sensor provided at a lower side of a door of a dishwasher according to an embodiment of the present disclosure.

FIG. 11 is a block diagram of a control device of a dishwasher according to an embodiment.

FIGS. 12A to 16B are flowcharts illustrating a method for controlling a dishwasher according to some embodiments of the present disclosure.

FIGS. 17 to 19 are diagrams illustrating lighting of a handle of a dishwasher according to some embodiments of the present disclosure.

### DETAILED DESCRIPTION

The above-described purposes, features, and advantages will be described in detail with reference to the accompanying drawings, and accordingly, a person having ordinary skill in the art to which the present disclosure pertains will be able to easily implement the technical idea of the present disclosure. In the description of the present disclosure, when it is determined that a detailed description of a known technology related to the present disclosure may unnecessarily obscure the gist of the present disclosure, the detailed description will be omitted. Hereinafter, preferred embodiments according to the present disclosure will be described in detail with reference to the accompanying drawings. In the drawings, the same reference numerals are used to indicate the same or similar components.

Although the first, second, and the like are used to describe various components, it is obvious that these components are not limited by these terms. These terms are used to distinguish only one component from another component. Unless otherwise stated, the first component may be the second component.

The present disclosure is not limited to the embodiments disclosed below, but various changes may be applied thereto and the present disclosure may be implemented in various different forms. However, the present embodiment is provided so that the present disclosure is complete and the scope of the present disclosure is fully informed to those skilled in the art. Therefore, embodiments of the present disclosure are not limited to the embodiments disclosed below, but it should be understood that a configuration of one embodiment and a configuration of another embodiment are substituted with each other or are added to each other, and all changes, equivalents, and substitutes included in the technical spirit and scope of the present disclosure are included in the present disclosure.

The accompanying drawings are only set forth for easy understanding of the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed to be larger or smaller in size or thickness in consideration of convenience of understanding, etc. However, the scope of the present disclosure should not be limited thereto.

The terms used herein are used only to describe specific embodiments or embodiments, and are not intended to limit the present disclosure. As used herein, the singular constitutes “a” and “an” are intended to include the plural constitutes as well, unless the context clearly indicates otherwise In the present disclosure, terms such as “include” and “comprise” are intended to designate that a feature, a number, a step, an operation, a component, a part, or a combination thereof as described in the present disclosure exist. That is, it should be understood that in the present disclosure, the terms such as “include” and “comprise” do not exclude the presence or addition of one or more other features, numbers, steps, operations, components, parts, or combinations thereof.

Terms including ordinals, such as first, second, etc., may be used to describe various components, but the components are not limited by the terms. The terms are used only for the purpose of distinguishing one component from another component.

When it is mentioned that one component is “connected” or “coupled” to another component, it should be understood that one component may be directly connected or coupled to another component, or still another component may be present therebetween. On the other hand, when it is mentioned that one component is “directly connected” or “directly coupled” to another component, it should be understood that still another component is absent therebetween.

When one component is referred to as “being disposed on top of” or “being disposed under” another component, it should be understood that one component may be directly disposed on top of or under another component or still another component may be present therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a dishwasher having a hidden door handle that automatically extends and a control method thereof will be described with reference to the drawings showing a configuration according to an embodiment of the present disclosure.

In the present disclosure, a front-rear direction refers to a direction based on front and rear sides of the dishwasher 1, and a left-right direction refers to a direction based on lateral sides of the dishwasher 1. A user uses the dishwasher 1 while being positioned in front of the dishwasher 1.

In the present disclosure, an outward direction of the door 30 may be defined as a frontward direction of the dishwasher 1.

### Overall Structure of Dishwasher

Hereinafter, the overall structure of the dishwasher 1 according to the present disclosure will be described in detail with reference to the accompanying drawings.

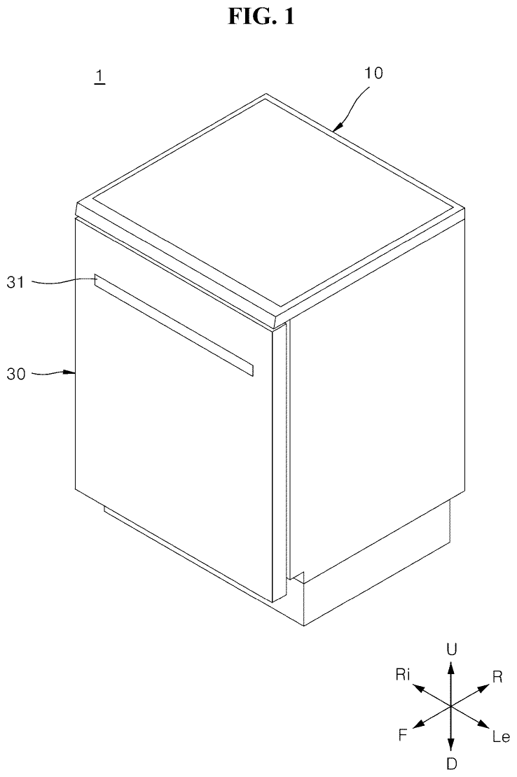

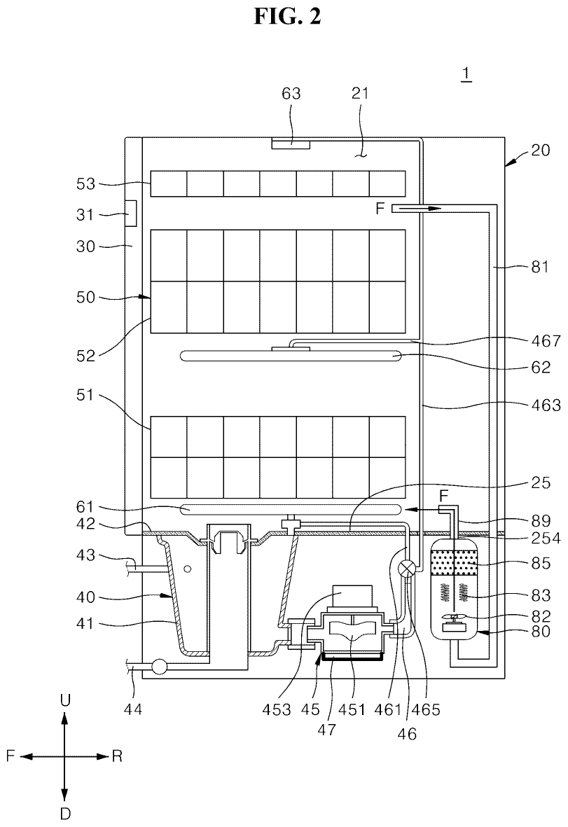

FIG. 1 is a front perspective view of a dishwasher according to an embodiment o the present disclosure. FIG. 2 is a schematic cross-sectional view of the dishwasher as shown in FIG. 1.

As shown in FIG. 1 and FIG. 2, a dishwasher 1 according to the present disclosure may include a casing 10 that constitutes an exterior appearance, a tub 20 installed in an inner space of the casing 10 and having a washing space 21 defined therein where the washing target is washed, wherein a front surface of the tub is open, a door 30 that opens/closes the open front surface of the tub 20, a driver device 40 located under the tub 20 to heat, supply, collect, circulate, and discharge the washing water for washing the washing target, a dish rack 50 removable provided in the inner washing space 21 of the tub 20 to receive therein the washing target, and a water sprayer 61, 62, and 63 installed adjacent to the dish rack 50 to spray the washing water for washing the washing target thereto.

In this regard, the washing target received in the dish rack 50 may be, for example, dishes such as bowls, plates, spoons, and chopsticks, and other cooking utensils. Hereinafter, unless otherwise specified, the washing target will be referred to as a dish.

The tub 20 may be formed in a box shape in which a front surface 22 is entirely open, and each of a rear surface 23, an upper surface 24, the lower surface 25, a right surface 27, and a left surface is in a closed state, and corresponds to a part known as a so-called washing tub.

A washing space 21 may be formed inside the tub 20, and the open front surface of the tub 20 may be opened and closed by a door 30.

The tub 20 may be formed via pressing of a metal plate resistant to high temperature and moisture, for example, a stainless steel plate.

Moreover, on an inner surface of the tub 20, a plurality of brackets may be disposed for the purpose of supporting and installing functional components such as the dish rack 50 and the water sprayer which will be described later thereon within the tub 20.

The driver device 40 may be configured to include a sump 41 for storing therein washing water used for washing and rinsing the washing target, a sump cover 42 for distinguishing the sump 41 from the tub 20, a water supply 43 for supplying the washing water from an external source to the sump 41, a water discharger 44 for discharging the washing water of the sump 41 out of the sump, a washing pump 45 for supplying the washing water of the sump 41 to the sprayer, a heating heater 47 for heating the washing water, and a supply flow path 46.

The sump cover 42 may be disposed at a top of the sump 41 and may serve to distinguish the tub 20 from the sump 41. Moreover, the sump cover 42 may have a plurality of collecting holes defined therein for collecting washing water sprayed into the washing space 21 through the water sprayer into the sump 41. The washing water sprayed from the water sprayer 61, 62, and 63 toward the dish may fall down to a bottom of the washing space 21, and may be collected again through the sump cover 42 and into the sump 41.

The washing pump 45 may be disposed at a side or a bottom of the sump 41 and may serve to pressurize the washing water and supply the pressurized washing water to the water sprayer. One end of the washing pump 45 may be connected to the sump 41 and the other end thereof may be connected to the supply flow path 46. The washing pump 45 may be equipped with an impeller 451 and a motor 453. When power is supplied to the motor 453, the impeller 451 may rotate, and thus the washing water in the sump 41 may be pressurized, and then may be supplied to the water sprayer through the supply flow path 46.

A heater assembly including a heating heater 47 may be disposed at a bottom surface of a housing of the washing pump 45. The heating heater 47 may be used to heat the washing water to be supplied to the washing pump 45. The heating heater 47 may heat the washing water used for washing and rinsing the washing target to a target temperature based on a control signal of a controller. For example, the heating heater 47 may heat the washing water based on a control signal corresponding to a washing cycle. In addition, the heating heater 47 may heat the washing water based on a control signal corresponding to a rinsing process. In addition, the heating heater 47 may heat the washing water based on a control signal corresponding to whether moisture-absorbing and drying is activated.

In addition, the heating heater 47 may heat the washing water to a varying target temperature in the washing cycle or the rinsing cycle in response to a control signal of the controller. In addition, the heating heater 47 may heat the washing water supplied in the rinsing process to a target temperature varying based on whether the moisture-absorption and drying is activated in response to the control signal of the controller. For example, the heating heater 47 may heat the washing water in the rinsing process to a higher temperature when the moisture-absorption and drying is activated than that when the moisture-absorption and drying is deactivated.

In one example, the supply flow path 46 may serve to selectively supply the washing water supplied from the washing pump 45 to the water sprayer.

For example, the supply flow path 46 may include a first supply flow path 461 connected to a lower spraying arm 61, and a second supply flow path 463 connected to an upper spraying arm 62 and a top nozzle 63. The supply flow path 46 may be provided with a supply flow path switching valve 465 that selectively opens/closes the supply flow paths 461 and 463.

In this regard, the supply flow path switching valve 465 may be controlled so that the supply flow paths 461 and 463 are opened sequentially or simultaneously.

In one example, the water sprayer may be configured to spray the washing water to the dishes stored in the dish rack 50.

More specifically, the water sprayer may include the lower spraying arm 61 located under the tub 20 to spray the washing water to a lower rack 51, the upper spraying arm 62 located between the lower rack 51 and an upper rack 52 to spray the washing water to the lower rack 51 and the upper rack 52, and the top nozzle 63 located on top of the tub 20 to spray the washing water to a top rack 53 or the upper rack 52.

In particular, the lower spraying arm 61 and the upper spraying arm 62 may be rotatably disposed in the washing space 21 of the tub 20 and may spray the washing water toward the dish of the dish rack 50 while being rotating.

The lower spraying arm 61 may be rotatably supported on a top of the sump cover 42 so as to spray the washing water toward the lower rack 51 while being rotating and being disposed under the lower rack 51.

Moreover, the upper spraying arm 62 may be rotatably supported by a spraying arm holder 467 so as to spray the washing water on the dish while being rotating and being disposed between the lower rack 51 and the upper rack 52.

In one example, although not shown, in order to increase washing efficiency, additional means for diverting the washing water sprayed from the lower spraying arm 61 into an upward direction (diverting in a U-direction) may be provided at a lower surface 25 of the tub 20.

The dish rack 50 for storing the dish therein may be disposed in the washing space 21. The dish rack 50 may be configured to extend or retract from or into the inner space of the tub 20 through the open front surface of the tub 20.

For example, in FIG. 2, an embodiment is shown in which the dish rack 50 includes the lower rack 51 located at a lower portion of the tub 20 to accommodate therein relatively large dishes, the upper rack 5 located on top of the lower rack 51 to accommodate therein medium-sized dishes, and the top rack 53 located at a top level of the tub 20 and capable of storing therein small dishes, etc. However, embodiments of present disclosure are not limited thereto. However, hereinafter, an example in which the dishwasher 1 includes the three dish racks 50 as shown is described.

Each of the lower rack 51, the upper rack 52, and the top rack 53 may be configured to extend or retract from or into the inner space of the tub 20 through the open front surface of the tub 20.

For this purpose, guide rails 54 may be respectively disposed on both opposing inner side surfaces constituting an inner surface of the tub 20. By way of example, the guide rails may include an upper rail 542, a lower rail 541, and a top rail 543.

Wheels may be disposed on a bottom of each of the lower rack 51, the upper rack 52, and the top rack 53. The user may extend the lower rack 51, the upper rack 52, and the top rack 53 from the inner space of the tub 20 through the open front surface of the tub 20 and may place the dishes thereon, or easily extend the dishes that have been washed out thereof.

The guide rail (not shown) may be embodied as a simple rail-type fixed guide rail to guide the extending or the retracting of the rack 50, or a telescopic guide rail capable of guiding the extending or the retracting of the rack 50 and at the same time, increasing an extension distance thereof as the rack 50 further extends from the inner space of the tub.

Although not shown, the rear panel 30b defining the inside of the door 30 may further be provided with a detergent supply device for automatically supplying detergent into the inside of the tub 20.

Furthermore, a door position sensor may be disposed on an outer top surface of the tub 20 and may be configured to detect whether the door 30 is in a closed or open state. For example, the door position sensor may include a door position sensor or a latch sensor or a limit sensor that detects a position of a door latch (not shown).

In one example, a moisture absorption and drying device 80 may be provided under the tub 20 and be configured to absorb water vapor contained in the air discharged from the tub 20 during the drying cycle and then resupply the water-vapor-free air to the tub 20 again.

The moisture absorption and drying device 80 may include a suction duct 81 through which air discharged from the tub 20 is sucked, a blower 82 for generating an airflow of the air, a heater 83 for heating the air sucked from the tub 20, and a moisture absorbent 85 for absorbing the water vapor contained in the air.

An air supply hole 254 through which the air from which the water vapor has been removed through the moisture adsorption and drying device 80 is introduced into the tub 20 may be defined in a lower surface 25 of the tub 20.

The airflow supplied into the tub 20 and then becoming humid while drying the dishes may be discharged to the outside, and the discharge of the airflow may be performed through partial opening of the door 30 or through a separate exhaust means (not shown).

As the dry air from the moisture-absorption and drying device 80 is supplied t the inside of the tub 20 during the drying process, the drying efficiency and sterilization effect of dishes may be significantly improved.

The door 30 has a purpose for opening and closing the open front surface of the tub 20 as described above. A hinge (not shown) around which the door 30 is closed or opened may be provided at a bottom of the open front surface. Thus, the door 30 may pivot around the hinge as a pivot axis.

A rear panel 30b constituting an inner side surface of the door 30 may constitute one surface of the tub 20 when the door 30 has been closed, and may constitute a seat surface on which the lower rack 51 of the dish rack 50 is supported when the door 30 is fully opened.

For this purpose, when the door 30 is fully opened downwardly, the rear panel 30b of the door 30 may constitute a horizontal plane extending in the same direction as a direction in which the guide rail 54 guiding the displacement of the lower rack 51 extends.

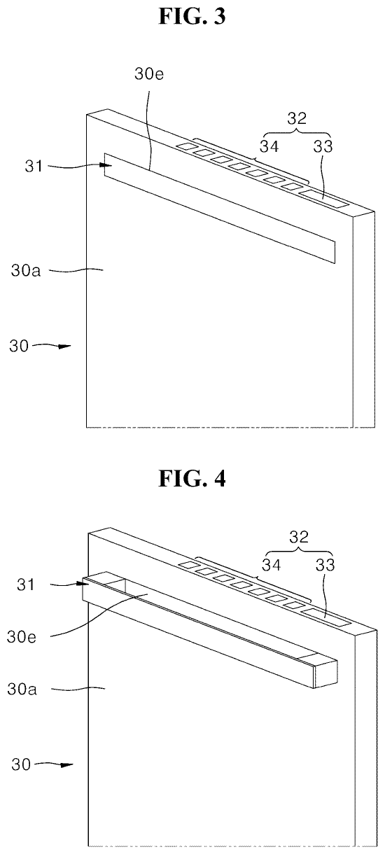

Referring to FIGS. 3 and 4, a handle 31 for opening the door 30 and a control panel 32 for controlling the operation of the dishwasher 1 may be provided on an outer surface of the door 30.

The control panel 32 may include a display 33 that visually displays information regarding a current operating status of the dishwasher 1, etc., and a button unit 34 including a selection button through which a user's course selection manipulation is input and a power button through which a user's manipulation for turning the dishwasher on and off is input.

The handle 31 of the dishwasher 1 according to the present disclosure may be configured to be at least partially accommodated in an inside of the door 30 when the handle is not in use, and to automatically extend in a protruding manner in a frontward direction from the door 30 when it is necessary to open and close the door 30.

In that the handle is configured to retract so as to be at least partially accommodated in the inside of the door 30 or extend in a protruding manner in a frontward direction from the door 30 out of the inside of the door 30, the handle 31 may be referred to as various names such as a pop-up handle, a retractable handle, an extendable handle, etc. Hereinafter, the handle 31 configured to retract into or extend from the door 30 of the dishwasher 1 according to one embodiment of the present disclosure will be referred to as the handle 31.

### Appearance and Operation of Handle

Hereinafter, with reference to FIGS. 3 to 6, the appearance and the operation of the handle 31 disposed at the door 30 of the dishwasher 1 according to one embodiment of the present disclosure will be described in detail.

As described above, the door 30 of the dishwasher 1 according to one embodiment of the present disclosure may be provided with the handle 31 that may be reciprocally movable. In this regard, as described above, the door 30 may be configured to be pivotable around the hinge (not shown) connected to a lower side of the door.

The handle 31 may be positioned at a position close to a top surface of the door 30 where the user may easily grasp the handle, and may be disposed at the front panel 30a constituting the front surface of the door 30 and may extend from or retract into the door.

Furthermore, the handle 31 may extend along an extension direction of a front edge of the top surface of the door 30 and along a left-right direction so that the user may easily grasp the handle. The handle 31 may be formed to have an approximate 90 degrees-rotated U shape.

In order to extend or retract the handle 31, an elongate opening 30e having a shape corresponding to an appearance of the handle 31 may be defined in the front panel 30a of the door 30 and extend along the extension direction of the front edge of the top surface of the door 30, and have a depth along a front-rear (F-R) direction

The handle 31 may be configured to reciprocate along the in a frontward direction and backward directions through the opening 30e of the front panel 30a under an operation of a handle driver as described below.

More specifically, the handle 31 may be disposed to reciprocate between the most frontward position and the most rearward position under the operation of the handle driver. In addition, the handle 31 may partially extend in a frontward direction according to the operation of the handle driver.

For convenience, hereinafter, the most frontward position to which the handle 31 is displaced in a frontward direction is defined as a maximal extended position Pd2 or a second position Pd2. The most rearward position to which the handle 31 is displaced in a backward direction is defined as a retracted position Pa, a default position Pa, or an returned position Pa. In addition, a position where the handle 31 has partially extended in a frontward direction is defined as a partially-extended position Pd1 or a first position Pd1.

FIG. 3 illustrates a state where the handle 31 has been displaced to the most rearward position, that is, the retracted position Pa, and thus has retracted into the inside of the door 30.

As shown, when the handle 31 has been displaced to the retracted position Pa, the handle 31 has at least partially retracted into the inside of the door 30. In this regard, preferably, the handle 31 may pass through an entirety of the opening 30e of the door 30 and retract into the inside of the door 30.

Furthermore, when the handle 31 has been displaced to the retracted position Pa, the handle 31 may be in a state where the handle 31 does not protrude from the front panel 30a of the door 30 in a frontward direction. Furthermore, when the handle 31 has been displaced to the retracted position Pa, a front end surface of the handle 31 may be coplanar with a front surface of the front panel 30a of the door 30 so as to form a continuous surface.

That is, when the handle 31 has been displaced to the retracted position Pa, a state in which no step is formed between the front surface of the front panel 30a of the door 30 and the front end surface of the handle 31 while an entirety of the opening 30e of the door 30 is closed may be formed. Thus, when the handle 31 has been displaced to the retracted position Pa, the opening 30e of the front panel 30a is entirely blocked, and at the same time, no step is formed between the front surface of the front panel 30a and the front end surface of the handle 31, such that the phenomenon in which foreign substances such as dusts accumulate on an convex portion of the door 30 or on the handle itself as in the conventional approach may be fundamentally prevented.

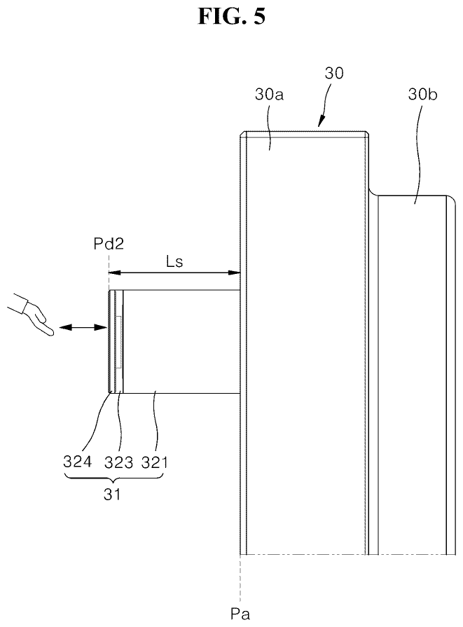

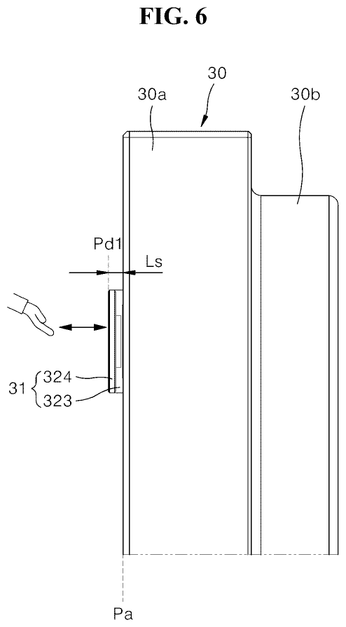

FIGS. 4 and 5 show a state in which the handle 31 has been displaced from the retracted position Pa to the maximally-extended position Pd2, and FIG. 6 shows a state in which the handle 31 has been displaced from the retracted position Pa to the partially-extended position Pd1 at which a portion of the handle has extended. In the present disclosure, the position at which the handle 31 has partially extended may be referred to as a partially-extended position Pd1 or the first position Pd1. In addition, the position at which the handle 31 has maximally extended may be referred to as the maximally-extended position Pd2 or the second position Pd2.

As shown in FIGS. 4 and 5, the handle 31 may extend from the retracted position Pa to the maximally-extended position Pd1. Moreover, as shown in FIG. 6, the handle 31 may extend from the retracted position Pa to the partially-extended position Pd1.

First, the handle 31 may extend to the partially-extended position Pd1 when a person is sensed by a first sensor 210 (shown in FIG. 10. The first sensor 210 may be provided at a lower side of the door 30 to maintain a seamless design of the front panel 30a of the door 30. For example, the first sensor 210 may be embodied as a proximity sensor. Alternatively, the first sensor 210 may be embodied as one of a RADAR (radio detection and ranging), a LIDAR (Light Detection Ranging), and a thermal sensor.

For example, the handle 31 may extend from the door by 5 mm in response to that the person has been detected by the first sensor 210. In an example, a stroke Ls by which the handle 31 is displaced from the retracted position Pa to the partially-extended position Pd1 may be in a range of 4 mm to 6 mm, preferably 5 mm. When the movement of the handle 31 to the partially-extended position Pd1 has been completed, a cover 324 and a light guide 323 of the handle 31 may be exposed. A first LED module 250 having a plurality of LED elements 3221 may be provided inside the handle 31, and light emitted from the first LED module 250 may be exposed through the light guide 323. The partially-extended position Pd1 or the first position Pd1 may correspond to a distance by which the handle 31 is displaced so as to extend from the inside of the door out of the door such that the light guide 323 is exposed to the user.

The determination of the displacement stroke Ls by which the handle 31 has partially extended is made in consideration of a distance by which the handle 31 is displaced so as to extend from the door such that the light emitted from the first LED module 250 may be exposed through the light guide 323 to the user. The displacement stroke Ls by which the handle 31 has partially extended is merely an example and may be designed to vary depending on a thickness of the light guide 323.

In addition, in response to that the person has been detected by the first sensor 210, the handle 31 may extend outwardly from the inside of the door 30 by 5 mm, and simultaneously, the first LED module 250 may be turned on to act as a preset welcome lighting. For example, the plurality of LED elements 3221 of the first LED module 250 may be turned on in an animation manner, and may be sequentially turned on a clockwise/counterclockwise rotation manner, or a left/right directional gradation manner (be sequentially turned on from a center to each of the left and right sides, or from each of the left and right sides to the center), thereby acting as the preset welcome lighting.

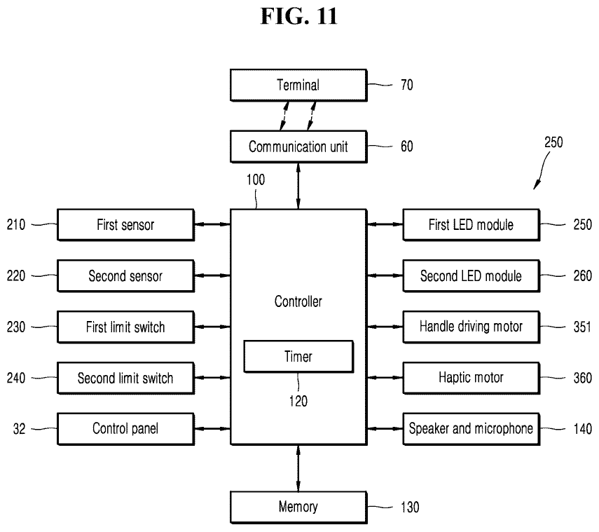

Next, the handle 31 may extend to the maximally-extended position Pd2 when a human hand is sensed by a second sensor 220 (shown in FIG. 11. The second sensor 220 may be provided inside the handle 31. The second sensor 220 is disposed in the inside of the handle 31, such that the front panel 30a of the door 30 may be maintained in a seamless design.

For example, the second sensor 220 may be embodied as a capacitance-based sensor capable of sensing a non-contact touch (air touch) or a contact touch. Thus, the second sensor 220 may sense the touch of the user on a front surface of the handle 31. The second sensor 220 may include a touch panel (or a touch electrode), and the touch panel may be mounted on a printed circuit board 322 provided in the handle. The second sensor 220 may detect the air touch or the contact touch based on a detecting result of a change in capacitance between the touch panel and the user's hand. However, embodiments of the present disclosure are not limited thereto, and any means capable of detecting whether the user's hand is proximal to the handle may be applied as the second sensor 220 without limitations thereof.

When the movement of the handle 31 to the maximally-extended position Pd2 has been completed, a handle body 321 of the handle 31 may be in a state in which the handle body 321 is entirely exposed to the outside out of the door 30 and in a state in which the user may grip the handle body 321. As the handle 31 is displaced to the maximally-extended position Pd2, the handle body 321 of the handle 31 exits the opening 30e of the front panel 30a of the door 30 and is exposed to the outside out of the door 30.

For example, the displacement stroke Ls by which the handle 31 is displaced from the retracted position Pa to the maximally-extended position Pd2 may be in a range of 40 mm to 50 mm, preferably 45 mm. The displacement stroke Ls of the handle 31 is merely an example and may be designed to vary according to the overall size of the dishwasher 1 and the front-rear size of the door 30.

### Detailed Structure of Handle

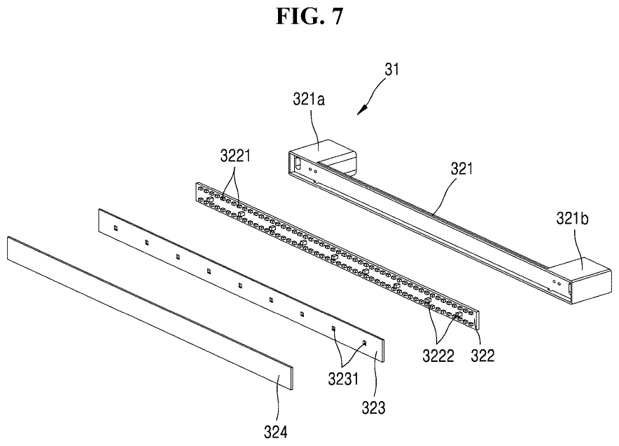

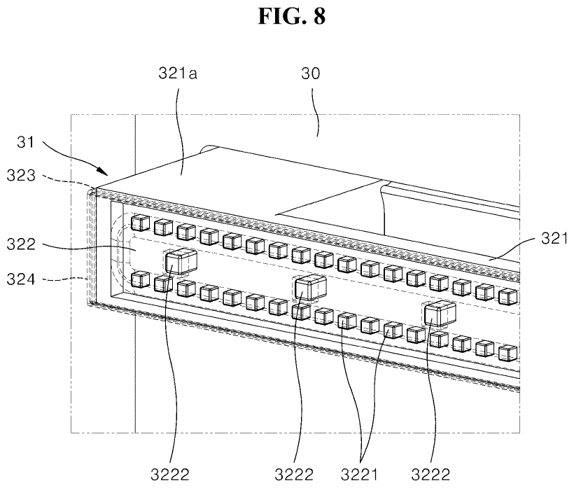

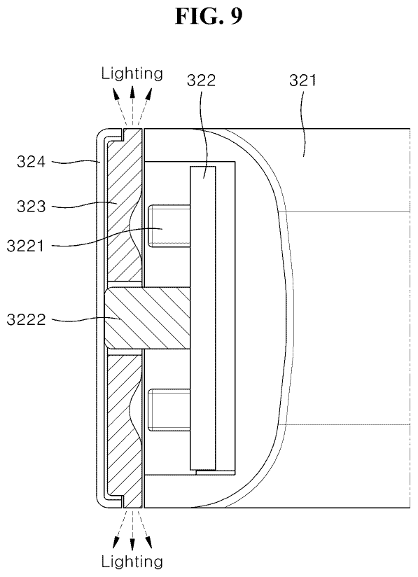

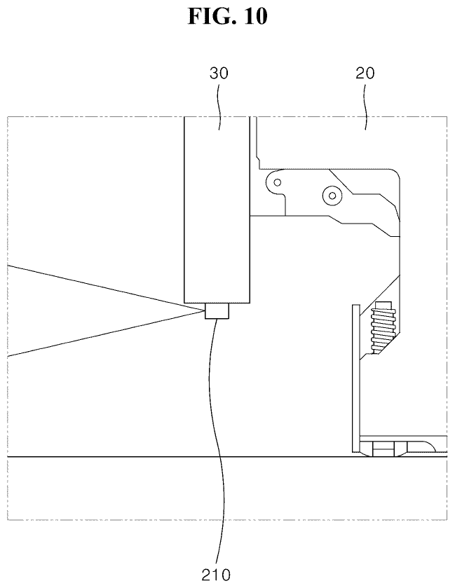

FIG. 7 is an exploded perspective view of a handle of a dishwasher according to an embodiment of the present disclosure. FIG. 8 is an enlarged perspective view of a handle of a dishwasher according to an embodiment of the present disclosure. FIG. 9 is a side cross-sectional view of the handle of FIG. 8.

Referring to FIG. 7, the handle 31 includes the handle body 321, the printed circuit board 322, the light guide 323, and the handle cover 324.

The handle body 321 extends in an elongate manner along the left-right direction and is disposed in the front panel 30a of the door 30 so as reciprocate in the front-rear direction. The handle body 321 includes a first handle body 321a and a second handle body 321b respectively coupled to both opposing sides in the left-right direction of the front panel 30a.

The handle driver may be disposed in each of the first handle body 321a and the second handle body 321b. A pair of handle drivers may be arranged so as to be spaced from each other along the left-right direction, and the driving forces respectively generated from the handle drivers may be transmitted to the first and second handles 321a and 321b, respectively. However, embodiments of the present disclosure are not limited thereto, and the handle 31 may be driven only by a single handle driver. In the present disclosure, a detailed configuration of the handle driver is not illustrated. However, the handle driver may include a pivot link having one end relatively pivotable with respect to the door and the other end connected to the handle to be relatively pivotable with respect thereto, a driving cam which presses the pivot link so that the pivot link pivots in a frontward direction when rotating in a forward direction, and presses the pivot link so that the pivot link pivots backwards when rotating in a reverse direction, and a handle driving motor 351 (shown in FIG. 11) which generates a rotational driving force for rotating the driving cam in the forward direction or the reverse direction.

The printed circuit board 322 may be disposed on a front surface of the handle body 321. The LED module having the plurality of LED elements 3221 is mounted on the printed circuit board 322. A plurality of gaskets 3222 for sensing proximity of a human hand is mounted on the printed circuit board 322. The plurality of gaskets 3222 may be connected to an internal touch electrode (not shown). For example, the touch electrode may be formed as a single plate-shaped touch panel. In another example, the touch electrode may be partitioned into a plurality of electrodes.

For example, respective one sides of the plurality of gaskets 3222 may be in contact with the handle cover 324, and the respective other sides of the plurality of gaskets 3222 may be electrically connected to the single plate-shaped touch electrode. The plurality of gaskets 3222 may be used to sense whether an air touch is made based on a change in capacitance of a capacitor between a human hand and a touch electrode when a user approaches the handle cover 324. In this case, the plurality of gaskets 3222 may be used to detect a position on the handle cover 324 which the hand approaches.

In another example, the respective one sides of the plurality of gaskets 3222 may be in contact with the handle cover 324, while the respective other sides of the plurality of gaskets 3222 may be electrically connected to a plurality of corresponding touch electrodes, respectively. For example, one gasket 3222 may be individually connected to one touch electrode. In this case, the plurality of gaskets 3222 may be used to detect a position on the handle cover 324 which the hand approaches or touches. The function of the dishwasher 1 may be controlled according to the touch position of the handle cover 324 by the hand. For example, when the hand touches the left or right edge of the handle cover 324, a pause function may be executed during the washing, rinsing, or drying cycle of the dishwasher 1. In addition, when the hand touches a middle area of the handle cover 324, a function may be executed so that the handle 31 extends to the maximally-extended position Pd2.

The plurality of LED elements 3221 may be disposed on each of upper and lower portions of a front surface of the printed circuit board 322 and may be arranged along a periphery of the handle 31. For example, the plurality of LED elements 3221 may be densely arranged along the periphery of the handle 31 so as to enable dynamic turn signal control.

The plurality of LED elements 3221 may be configured to be turned on in an animation manner, and to be sequentially turned on a clockwise/counterclockwise rotation manner, or a left/right directional gradation manner (be sequentially turned on from a center to each of the left and right sides, or from each of the left and right sides to the center), thereby acting as the preset welcome lighting. In addition, the plurality of LED elements 3221 may be configured to emit light such that a color of the light may vary according to a washing, rinsing, or drying process. In addition, the plurality of LED elements 3221 may be configured such that the number of turned on LED elements 3221 arranged in the left-right direction gradually increases according to the elapsed time duration of the washing, rinsing, or drying process. In addition, the plurality of LED elements 3221 may be configured to emit red light for a notification for preventing hand pinching. In addition, the plurality of LED elements 3221 may be configured to emit light such that the color of the light may vary according to the internal temperature of the dishwasher 1 when the user temporarily stops the operation of the dishwasher 1 and attempts to open the door 30.

The plurality of gaskets 3222 may be arranged along a middle line in a vertical direction of the front surface of the printed circuit board 322 and in the left-right direction. For example, the plurality of gaskets 3222 may be arranged along the left-right direction and in the middle line disposed between the upper array and the lower array of the plurality of LED elements 3221 disposed on the front surface of the printed circuit board 322.

The light guide 323 may be disposed on the front surface of the printed circuit board 322, and each gasket hole 3231 for guiding each of the plurality of gaskets 3222 to contact the handle cover 324 may be formed in the light guide 323. The gasket holes 3231 may be arranged along the vertical middle line and in the left-right direction. The light guide 323 may be made of a light guide material that diffuses light when the plurality of LED elements 3221 emit the light. The light guide 323 may be exposed in the frontward direction when the handle 31 has extended out of the door 30, and may diffuse the light from the plurality of LED elements 3221 along the periphery of the handle 31.

The light guide 323 may also be referred to as a light diffusion plate or film for diffusing the light. The light guide 323 may be made of a material having excellent transparency, good workability, and excellent light diffusion ability. For example, the light guide 323 may be made of a material such as polycarbonate (PC), PMMA (polymethyl methacrylate), polyethylene terephthalate (PET), fluororesin (e.g., PTFE, Teflon), polypropylene (PP), silicone, or the like.

The handle cover 324 is disposed on a front surface of the light guide 323 and is in physical contact with the respective one sides of the plurality of gaskets 3222. For example, the handle cover 324 may be formed to have the same texture as that of the front panel 30a of the door 30. For example, the handle cover 324 may be made of a metal material when the second sensor 220 is embodied as a sensor configured to sense a non-contact touch of one point. Alternatively, the handle cover 324 may be made of a non-metal material when the second sensor 220 is embodied as a sensor configured to sense a non-contact touch of a plurality of points.

### Device and Method for Controlling Handle

FIG. 11 is a block diagram of a control device of a dishwasher according to an embodiment.

Referring to FIG. 11, the control device of the dishwasher 10 includes the first sensor 210, the second sensor 220, a first limit switch 230, a second limit switch 240, a control panel 32, the first LED module 250, a second LED module 260, the handle driving motor 351, a haptic motor, a speaker and a microphone 140, and a controller 100.

The first sensor 210 detects a person within a first distance from the dishwasher 1. The first sensor 210 may be provided at the lower side of the door 30 to maintain the seamless design of the front panel 30a of the door 30. In addition, the first sensor 210 may be used as a sensor for activating a sensing function of the second sensor 22. For example, when a person within the first distance from the dishwasher 1 is sensed by the first sensor 210, the controller 100 may be configured to apply a touch driving signal to the second sensor 220 to activate a sensing function of the second sensor 220 so that the second sensor 220 may sense the proximity of the human hand.

In response to that the person approaches a position within the first distance from the dishwasher 1 based on a distance of the person sensed by the first sensor 210 from the dishwasher 1, the controller 100 may be configured to allow the handle 31 to extend to the first position Pd1. For example, the first distance may be set to 50 cm from the dishwasher 1, and the first position Pd1 may be set to a position corresponding to the displacement stroke Ls of 5 mm. In an example, the controller 100 may be configured to allow the handle 31 to be displaced to the first position Pd1 when the person approaches a position within 50 cm from the dishwasher 1 and stays at the position within the first distance for 1 or larger second.

In addition, the controller 100 may be configured to activate the second sensor 220 in response to that the person approaches a position within the first distance from the dishwasher 1 based on the distance between the person measured by the first sensor 210 and the dishwasher 1.

For example, the first sensor 210 may be embodied as a proximity sensor that detects the proximity of an object located in front of the dishwasher 1.

In another example, the first sensor 210 may be embodied as a position sensitive detector (PSD) sensor. The PSD sensor is a sensor for detecting a position using a light source. The PSD sensor is an optical sensor used to measure the position of incident light, and may determine the position of the object based on a measuring result of a current distribution generated when light or particles collide with a sensor surface. The PSD sensor may be referred to as a position detection sensor or a light position detector.

In still another example, the first sensor 210 may be embodied as a time of flight (TOF) sensor. The TOF sensor is a sensor that is configured to emit light of a specific wavelength, to measure a time for which the light is emitted to the object and is reflected from the object and returns thereto, and to calculate the distance from the object based on the measured time. The TOF sensor accurately measures a round trip time of light, and calculates the distance between the object and the sensor in real time using the time duration for which the light is emitted to and is reflected from the object and returns to the sensor.

In still yet another example, the first sensor 210 may be embodied as an ultrasonic sensor. The ultrasonic sensor is a sensor that is configured to transmit sound waves to the object and to receive reflected waves reflected form the object and to measure the distance to the object based on the reception of the reflected waves. The ultrasonic sensor may precisely calculate the distance to the object based on a measuring result of the time duration between the transmitting of the sound wave and the reception of the reflected wave.

In still yet another example, the first sensor 210 may be embodied as a radar sensor. The radar sensor may be configured to transmit radio waves, receive reflected waves, measure a time duration between the transmission and the reception of the radio waves, and to calculate the distance to the object based on the time duration. The radar sensor may monitor various information such as an angle, a position, and a speed of the object based on a phase difference between the transmitted wave and the reflected wave.

In still yet another example, the first sensor 210 may be embodied as a Lidar sensor. The Lidar sensor is configured to measure a time duration for which laser light is emitted toward and is reflected from the object and returns thereto using a time of flight (TOF) principle and to calculate the distance to the object based on the measured time duration. The Lidar sensor may recognize a sensor value of surrounding environments while rotating by 360 degrees using a motor.

In still yet another example, the first sensor 210 may include a thermal sensor. The thermal sensor is a sensor configured to detect heat emitted from a human body or an object and identify the location of the object based on the analysis of the detected heat. The thermal sensor detects the object using infrared radiation energy and does not use light, so that it may work effectively even in dark environments.

The second sensor 220 detects the human hand within a second distance from the handle 31. The second sensor 220 may be provided inside the handle 31. The second sensor 220 may be received in the inside of the handle 31, such that the front panel 30a of the door 30 may be maintained in a seamless design. The second sensor 220 may be used to extend the handle 31 to the second position Pd2 when the human hand is sensed thereby. In addition, the second sensor 220 may be used to detect whether the user's hand is caught into between the handle 31 and the door 30.

When a person is determined to be present within the first distance based on the detection result of the first sensor 210, the second sensor 220 may activate the sensing function thereof under the control of the controller 100. For example, the second sensor 220 may include the touch electrode, and the controller 100 may be configured to apply the touch driving signal to the touch electrode of the second sensor 220 to activate the second sensor 220 to detect the object. In the present disclosure, the on state of the second sensor may mean a state in which the touch function thereof is activated, and the off state of the second sensor may mean a state in which the touch function thereof is deactivated. For example, the second sensor 220 may be in an inactive state in the standby state of the dishwasher 1, and may be switched to an active state under the control of the controller 100 in response to that a person is determined to be present within the first distance based on the detection result of the first sensor 210.

The controller 100 may be configured to allow the handle 31 to extend to the second position Pd2 in response to that the human hand approaches a position within the second distance from the handle based on the signal sensed by the second sensor 220. For example, the second distance may be set to 5 cm, and the second position may be set to a position corresponding to the displacement stroke of the handle of 45 mm.

For example, the second sensor 220 may be embodied as a capacitance-based sensor capable of sensing a non-contact touch (air touch) or a contact touch of the front surface of the handle 31 by the user. The second sensor 220 may include the touch electrode, and the touch electrode may be mounted on the printed circuit board 322 provided inside the handle. The second sensor 220 may sense the air touch or the contact touch based on a sensing result of a change in capacitance between the touch electrode and the user's hand.

In another example, the second sensor 220 may be embodied as a capacitance-based sensor including a plurality of partitioned touch electrodes. A preset UI function may be performed according to a touch position or a touch pattern of the handle 31. For example, when a central portion of the handle 31 is touched by the user, a function of extending the handle to the second position Pd2 may be set to be performed. When a left portion or a right portion of the handle 31 is touched by the user, a function of temporarily stopping the operation of the dishwasher 1 or popping-in the handle into the first position Pd1 may be set to be performed. As described above, the handle 31 may be used as a means for performing the preset UI function.

The handle driving motor 351 is used to reciprocate the handle in the front-rear direction. The handle driving motor 351 may be included in the handle driver provided in each of the first and second handle bodies 321a and 321b. The handle driving motor 351 generates a rotational driving force for rotating the driving cam in the forward direction or the reverse direction.

As described above, the controller 100 may be configured to control the handle driving motor 351 to extend the handle 31 to the first position Pd1 in response to that the person has been detected by the first sensor 210, and to control the handle driving motor 351 to extend the handle 31 to the second position Pd2 at which the handle has extended in the frontward direction beyond the first position Pd1 when a human hand is sensed by the second sensor 220.

The first limit switch 230 senses the closed state of the handle 31 and provides a sensing signal thereof to the controller 100. The closed state of the handle 31 indicates a state in which the handle 31 has been displaced to the rearmost position or the retracted position Pa, and has been entirely inserted into the door 30. The second limit switch 240 detects a closed state of the door 30 and provides a sensing signal thereof to the controller 100.

The control panel 32 may include a button 34 to which a user's manipulation input and a display 33 for displaying a current operating state. In addition, the control panel 32 may include a second LED module 260 for displaying the manipulation state of the button 34. The second LED module 260 may be used in the display 33 that displays the current operating state.

The first LED module 250 may be provided inside the handle 31. The plurality of LED elements 3221 of the first LED module 250 may be arranged along the upper line and the lower line of the front surface of the printed circuit board 322 and along the periphery of the handle 31. The first LED module 250 may be used as a welcome lighting. In addition, the first LED module 250 may be configured to emit light such that the color of the light varies according to a washing, rinsing, or drying cycle to indicate a cycle state.

In addition, the plurality of LED elements 3221 may be configured such that the number of turned on LED elements 3221 arranged in the left-right direction gradually increases according to the elapsed time duration of the washing, rinsing, or drying process and thus may be used as a lighting indicating the elapsed time duration. In addition, the plurality of LED elements 3221 may be configured to emit red light for a notification for preventing hand pinching. In addition, the plurality of LED elements 3221 may be configured to emit light such that the color of the light may vary according to the internal temperature of the dishwasher 1 and thus may be used as a lighting for warning of a safety accident.

The haptic motor 360 may be provided in the handle 31 and may act as one o the means for warning of hand pinching. In one example, the haptic motor 360 serves to generate vibration in the handle 31 upon detection that the hand is caught into between the handle 31 and the door 30.

The speaker and microphone 140 may be used to notify or guide a mode selection or an operation state of the dishwasher 1. In addition, the speaker and microphone 140 may be used to notify a warning when the hand pinching is detected or an action of opening the door 30 is detected in a state in which the internal temperature in the dishwasher 1 is high. In addition, the speaker and microphone 140 may be used to recognize the voice to control the dishwasher 1.

The controller 100 may be configured to receive an input signal from the control panel 32, to receive a detection signal from each of the sensors, and may control each load according to the input signal or the detection signal of each of the sensors.

The controller 100 may be configured to include at least one processor. The processor may include one or more of a central processing unit (CPU), an application processor, or a communication processor. Moreover, the controller 100 may be configured to include a timer 120. In addition, the controller 100 may be configured to include an analog-to-digital converter that converts a signal detected from the sensor into a digital signal. In addition, the controller 100 may be configured to include a driver for driving each of the motors. In addition, the controller 100 may be configured to include a driver for driving each of the LED modules. In addition, the controller 100 may be configured to include a driver for driving the touch electrode disposed in the handle.

For example, the controller 100 may be configured to include a touch driving circuit. The controller 100 may be configured to apply the touch driving signal TDS to the touch electrode of the second sensor 220 through the touch driving circuit TDC, and may receive a feedback signal from the touch electrode. The controller 100 may be configured to determine that the human hand is close to the handle 31 based on a detecting result of a change in the feedback signal due to the change in the capacitance between the human hand and the touch electrode.

A memory 130 may store therein data or a program for controlling the dishwasher 130. In addition, various parameters such as an operation condition and a time condition for each of the cycles pre-stored based on each washing course may be stored in the memory 130. In addition, data or a program for controlling the handle 31 may be stored in the memory 130.

A communication unit 60 may be used to communicate with an external terminal 70. For example, the communication unit 60 may communicate with a remote controller or a smart terminal of the user. An application for controlling or setting the dishwasher 1 may be installed in the smart terminal. The user may control the dishwasher 1 or set an operation mode through the smart terminal. For example, the user may use the remote controller or the smart terminal capable of communicating with the communication unit 60 to select and set the welcome lighting of the dishwasher 1.

Upon determination that the user approaches the dishwasher 1 based on the sensing result from the first sensor 210, the controller 100 may be configured to drive the handle driving motor 351 of the handle driver in the forward direction to move the handle 31 in the frontward direction to the first position Pd1.

In addition, in response to that the user's hand is sensed by the second sensor 220 after the handle 31 has been displaced to the first position Pd1, the controller 100 may be configured to additionally drive the handle driving motor 351 in the forward direction to move the handle 31 in then frontward direction to the second position Pd2.

In addition, in response to that a user's manipulation command is input from the control panel 32, the controller 100 may be configured to control the dishwasher 1 to turn on/off the power of the dishwasher 1 or to perform the individual cycle of the dishwasher 1 according to the selected washing course and the selected operation mode. In addition, the controller 100 may be configured to receive the user's manipulation command from the external terminal via the communication unit 60.

In addition, the controller 100 may be configured to receive the detection signal from the first limit switch 230 and determine whether the handle 31 is at the first position Pd1, the second position Pd2, or the retreat position Pa based on the received detection signal.

In addition, the controller 100 may be configured to receive the detection signal from the second limit switch 240 and determine whether the door 30 is currently in a closed state or an open state based on the received detection signal. In addition, when the door 30 needs to be opened in a state in which the door 30 is closed, the controller 100 may be configured to operate the handle driver to move the handle 31 in the frontward direction to the second position Pd2.

In addition, the controller 100 may be configured to determine whether a user's hand or another object is sandwiched between the handle 31 and the door 30 through a signal received from the second sensor 220. In addition, the controller 100 may be configured to determine whether a user's hand or another object is sandwiched between the handle 31 and the door 30 through a signal received from a current sensor (not shown) that detects overload of the handle driving motor 351 when the handle 31 moves backwards.

In addition, the controller 100 may be configured to control the lighting of the first LED module 250 at the same time as or subsequent to a time at which the movement in the frontward direction of the handle 31 to the first position Pd1 is started.

In addition, in response to that it is determined that the user's hand or the object is sandwiched between the handle 31 and the door 30 after the backward movement of the handle 31 is started based on the signal received from the second sensor 220, the controller 100 may be configured to drive the haptic motor 360 to generate the vibration.

In addition, when the user's hand or the object is caught into or between the handle 31 and the door 30 based on the signal received from the second sensor 220, the controller 100 may be configured to generate a voice notification or a sound notification through the speaker 140 to guide the user to remove the hand or the object from the handle 31. For example, the voice notification may include guidance information or warning information says “Please remove your hand form a handle. I'll close the handle” or “Please remove the object from the handle. I will close the handle”.

In addition, the controller 100 may be configured to invoke the operation condition, the time condition, etc. for each cycle based on each washing course pre-stored in the memory 130 and generate a control signal for controlling the execution and termination of the cycle according to the washing course using the operation condition or the time condition.

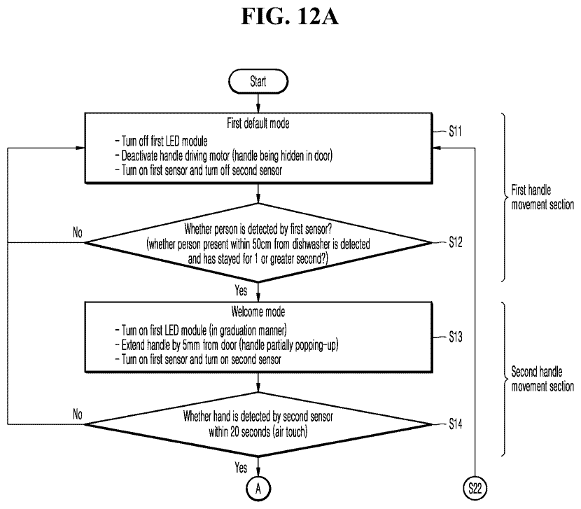

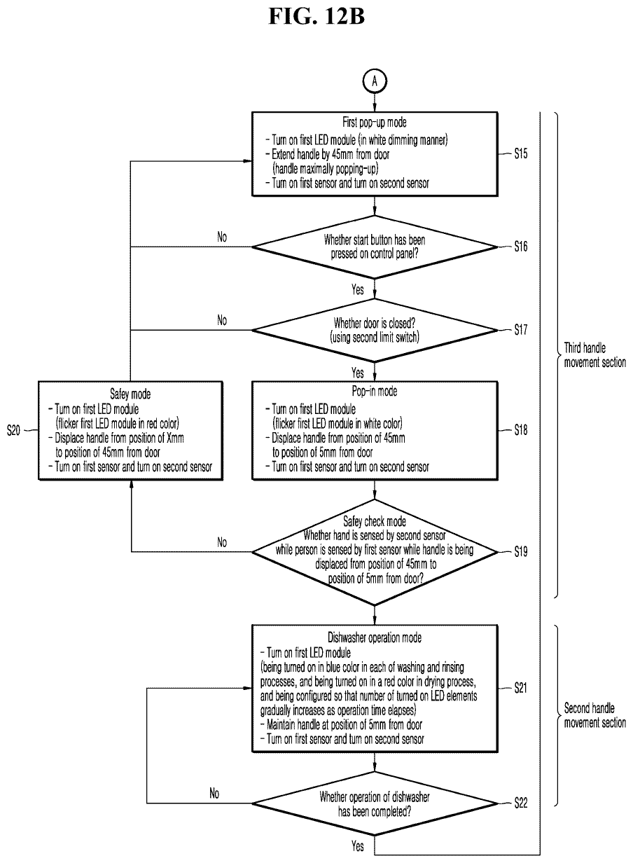

Hereinafter, a method for controlling the dishwasher 1 according to some embodiments of the present disclosure will be described with reference to FIGS. 12A to 16B.

In the present disclosure, a first handle movement section corresponds to a state in which the handle 31 is hidden inside the door 30. A second handle movement section corresponds to a state in which the handle 31 extends to the first position Pd1 inside the door 30. In an example, the second handle movement section may correspond to a state in which the handle 31 has been displaced in a frontward direction from the front panel 30a of the door 30 by 5 mm. A third handle movement section corresponds to a state in which the handle 31 has extended from the inside of the door 30 to the second position Pd2. For example, the third handle movement section may correspond to a state in which the handle 31 has been displaced in a frontward direction from the front panel 30a of the door 30 by 45 mm.

FIGS. 12A to 16B are flowcharts illustrating a method for controlling a dishwasher according to some embodiments of the present disclosure. In describing some embodiments of the present disclosure, descriptions of components that are the same as or correspond to those of the previous embodiment may be omitted.

FIGS. 12A and 12B are a flowchart illustrating a method for controlling the dishwasher 1 according to an embodiment of the present disclosure.

Referring to FIGS. 11, 12A and 12B, first, the controller 100 of the dishwasher 1 determines whether a person is sensed by the first sensor 210 in a standby state S11 of a first default mode in S12. In the first default mode, the first LED module 250 may be turned off, the handle driving motor 351 may not be activated (a state in which the handle is hidden inside the door), the first sensor 210 may be turned on, and the second sensor 220 may be turned off.

When a person is detected to be present within 50 cm from the dishwasher 1 by the first sensor 210 and it is determined that the person has stayed for one or more seconds, the controller 100 operates the dishwasher 1 in a welcome mode in S13. In the welcome mode, the controller 100 allows the handle driving motor 351 to operate to partially extend the handle 31 by 5 mm in a frontward direction, turns on the first LED module 250 to act as the welcome lighting, and turns on the second sensor 220 in S13.

The controller 100 determines whether a human hand is detected within 20 seconds after a time point at which the person is detected by the first sensor 210 by the second sensor 220 in S14.

When the human hand is sensed within 20 seconds after a time point at which the person is detected by the first sensor 210 by the second sensor 220, the controller 100 operates the handle of the dishwasher 1 in a first pop-up mode. In the first pop-up mode, the controller 100 drives the handle driving motor 351 to maximally extend the handle 31 by 45 mm in a frontward direction, and turns on the first LED module 250 in a white dimming manner in S15.

The controller 100 determines whether a start button has been activated on the control panel 32 after setting the cycle mode of the dishwasher 1 in S16. When the start button has been activated on the control panel 32, the controller 100 determines whether the door 30 has been closed using the second limit switch 240 in S17.

When the door 30 has been closed, the controller 100 operates the handle 21 in pop-in mode. That is, the controller 100 drives the handle driving motor 351 to move the handle 31 from a position corresponding to the displacement stroke of 45 mm to a position corresponding to the displacement stroke of 5 mm, and flicker the first LED module 250 in a white color in S18.

The controller 100 operates the dishwasher 1 in a safety check mode while moving the handle 31 from a position corresponding to the displacement stroke of 45 mm to a position corresponding to the displacement stroke of 5 mm. The controller 100 determines whether the hand of the person is sensed while the person is sensed based on the sensing signals of the first sensor 210 and the second sensor 220 in the safety check mode in S19.

In response to that the human hand is detected while the handle 31 is being displaced from a position corresponding to the displacement stroke of 45 mm to a position corresponding to the displacement stroke of 5 mm, the controller 100 operates the dishwasher 1 in a safety mode in S20. In the safety mode, the controller 100 may be configured to drive the handle driving motor 351 to move the handle 31 from a position corresponding to the displacement stroke of Xmm to a position corresponding to the displacement stroke of 45 mm, to flicker the first LED module 250 in a red color, and to drive the haptic motor 360 to generate the vibration.

When it is determined that the handle 31 is not caught into between the door and the handle in the safety check mode, the controller 100 completes the operation of moving the handle 31 to the position corresponding to the displacement stroke of 5 mm and operates the dishwasher 1 in a washing operation mode in S21. In this regard, the controller 100 may be configured to turn on the first LED module 250 in a cycle-dependent color in the washing operation mode.

For example, the first LED module 250 may be turned on in a blue color in each of the washing and rinsing processes, and may be turned on in a red color in the drying process, and may be turned on so that the number of LED elements 3221 turned on at a high luminance level and arranged in the left-right direction gradually increases in the first direction, in one example, a direction from a left side to a right side as the operation time of the dishwasher 1 elapses.

The controller 100 determines whether the operation of the dishwasher 1 has been completed in S22.

In response to that the operation of the dishwasher 1 has been completed, the controller 100 operates the dishwasher 1 in the first default mode in S11. In the first default mode, the first LED module 250 is turned off, the handle 31 is hidden inside the door 30, the first sensor 210 is turned on, and the second sensor 220 is turned off.

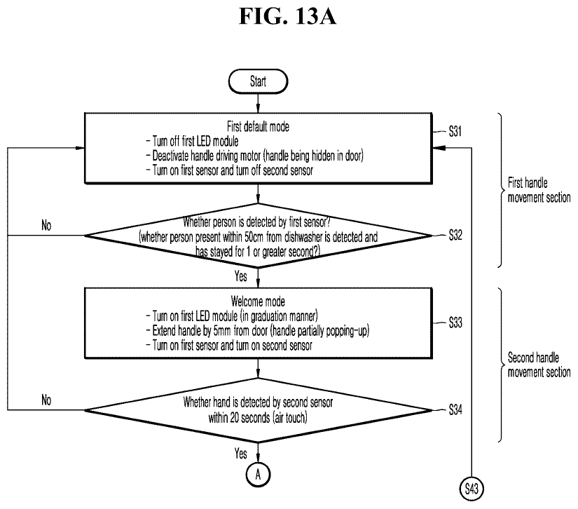

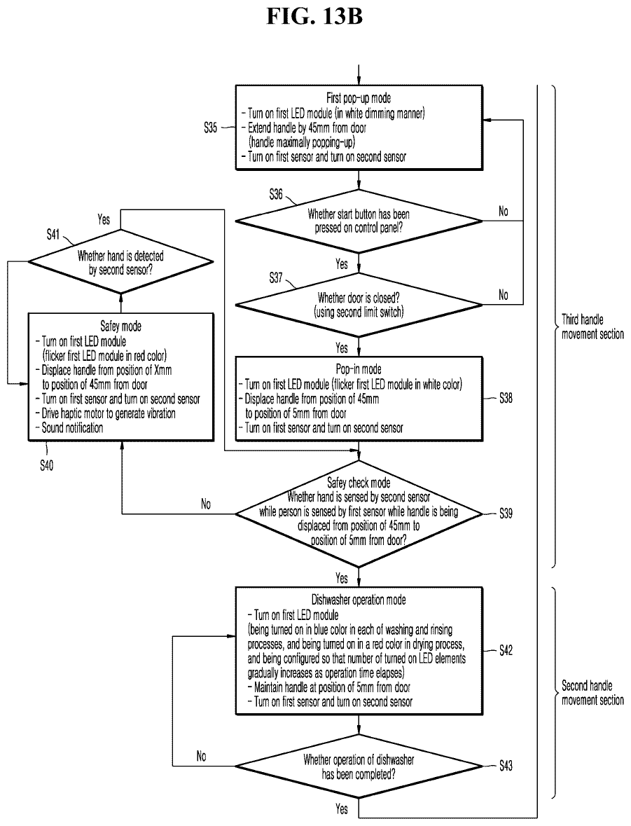

FIGS. 13A and 13B are a flowchart illustrating a method for controlling the dishwasher 1 according to another embodiment of the present disclosure.

Referring to FIGS. 11, 13A and 13B, the controller 100 of the dishwasher 1 determines whether a person is detected by the first sensor 210 in a standby state S31 of the first default mode in S32. In the first default mode, the first LED module 250 may be turned off, the handle driving motor 351 may be deactivated (a state in which the handle is hidden inside the door), the first sensor 210 may be turned on, and the second sensor 220 may be turned off.

When a person is detected to be present within 50 cm from the dishwasher 1 by the first sensor 210 and it is determined that the person has stayed for one or more seconds, the controller 100 operates the dishwasher 1 in a welcome mode in S33. In the welcome mode, the controller 100 allows the handle driving motor 351 to operate to partially extend the handle 31 by 5 mm in a frontward direction, turns on the first LED module 250 to act as the welcome lighting, and turns on the second sensor 220 in S33.

The controller 100 determines whether the human hand is sensed by the second sensor 220 disposed in the handle 31 in S34. For example, the controller 100 determines whether the human hand is detected within 20 seconds after a time point at which the person is detected by the first sensor 210 by the second sensor 220 in S34.

When the human hand is sensed within 20 seconds after a time point at which the person is detected by the first sensor 210 by the second sensor 220, the controller 100 operates the handle of the dishwasher 1 in the first pop-up mode in S35. In the first pop-up mode, the controller 100 drives the handle driving motor 351 to maximally extend the handle 31 by 45 mm in a frontward direction, and turns on the first LED module 250 in a white dimming manner in S35.

The controller 100 determines whether a start button has been activated on the control panel 32 after setting the cycle mode of the dishwasher 1 in S36. When the start button has been activated on the control panel 32, the controller 100 determines whether the door 30 has been closed using the second limit switch 240 in S37.

When the door 30 has been closed, the controller 100 operates the handle 21 in pop-in mode. That is, the controller 100 drives the handle driving motor 351 to move the handle 31 from a position corresponding to the displacement stroke of 45 mm to a position corresponding to the displacement stroke of 5 mm, and flicker the first LED module 250 in a white color in S38.

The controller 100 operates the dishwasher 1 in a safety check mode while moving the handle 31 from a position corresponding to the displacement stroke of 45 mm to a position corresponding to the displacement stroke of 5 mm. The controller 100 determines whether the hand of the person is sensed while the person is sensed based on the sensing signals of the first sensor 210 and the second sensor 220 in the safety check mode in S39.

In response to that the human hand is detected while the handle 31 is being displaced from a position corresponding to the displacement stroke of 45 mm to a position corresponding to the displacement stroke of 5 mm, the controller 100 operates the dishwasher 1 in a safety mode in S40. In the safety mode, the controller 100 may be configured to drive the handle driving motor 351 to move the handle 31 from a position corresponding to the displacement stroke of Xmm to a position corresponding to the displacement stroke of 45 mm, to flicker the first LED module 250 in a red color, and to drive the haptic motor 360 to generate the vibration.

After the safety mode has been completed in S40, the controller 100 checks whether a human hand is sensed by the second sensor 220 in S41. In this regard, when it is determined that the human hand is not sensed, the controller 100 moves the handle 31 from a position corresponding to the displacement stroke of 45 mm to a position corresponding to the displacement stroke of 5 mm again, and operates the dishwasher 1 in the washing operation mode in S42. The controller 100 may be configured to perform at least one of washing, rinsing, and drying in the washing operation mode.

The controller 100 determines whether the washing operation mode of the dishwasher 1 has been completed in S43. When the washing operation mode of the dishwasher 1 has been completed, the controller 100 operates the dishwasher 1 again in the first default mode.

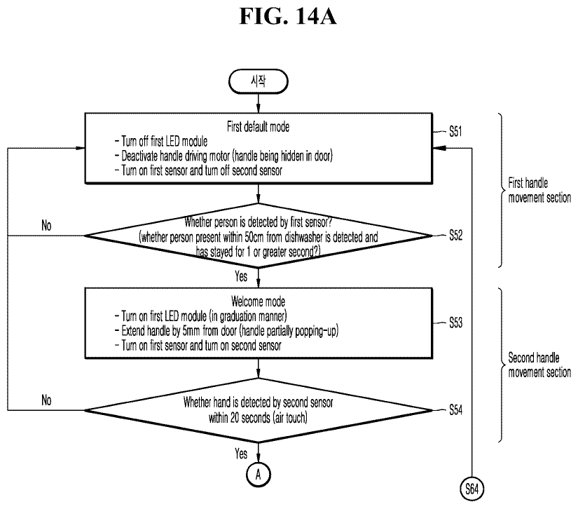

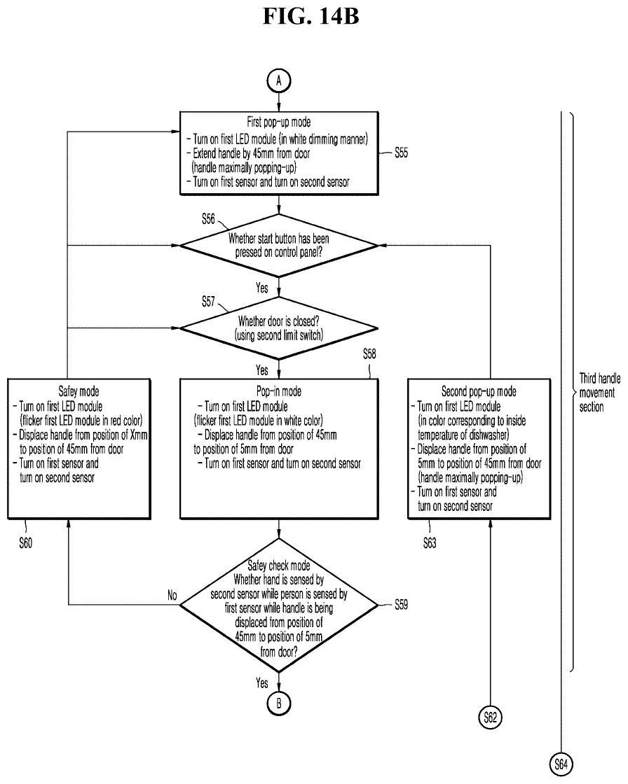

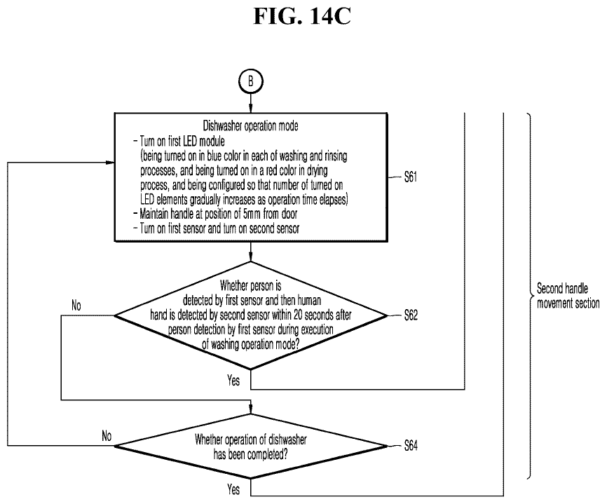

FIGS. 14A, 14B and 14C are a flowchart illustrating a method for controlling the dishwasher 1 according to still another embodiment of the present disclosure.

Referring to FIGS. 11, 14A, 14B and 14C, first, the controller 100 of the dishwasher 1 determines whether a person is sensed by the first sensor 210 in a standby state S51 of a first default mode in S52. In the first default mode, the first LED module 250 may be turned off, the handle driving motor 351 may not be activated (a state in which the handle is hidden inside the door), the first sensor 210 may be turned on, and the second sensor 220 may be turned off.

When a person is detected to be present within 50 cm from the dishwasher 1 by the first sensor 210 and it is determined that the person has stayed for one or more seconds, the controller 100 operates the dishwasher 1 in a welcome mode in S53. In the welcome mode, the controller 100 allows the handle driving motor 351 to operate to partially extend the handle 31 by 5 mm in a frontward direction, turns on the first LED module 250 to act as the welcome lighting, and turns on the second sensor 220 in S53.

The controller 100 determines whether the human hand is sensed by the second sensor 220 disposed in the handle 31 in S54. For example, the controller 100 determines whether the human hand is detected within 20 seconds after a time point at which the person is detected by the first sensor 210 by the second sensor 220 in S54.

When the human hand is sensed within 20 seconds after a time point at which the person is detected by the first sensor 210 by the second sensor 220, the controller 100 operates the handle of the dishwasher 1 in a first pop-up mode. In the first pop-up mode, the controller 100 drives the handle driving motor 351 to maximally extend the handle 31 by 45 mm in a frontward direction, and turns on the first LED module 250 in a white dimming manner in S55.

The controller 100 determines whether a start button has been activated on the control panel 32 after setting the cycle mode of the dishwasher 1 in S56. When the start button has been activated on the control panel 32, the controller 100 determines whether the door 30 has been closed using the second limit switch 240 in S57.

When the door 30 has been closed, the controller 100 operates the handle 21 in pop-in mode. That is, the controller 100 drives the handle driving motor 351 to move the handle 31 from a position corresponding to the displacement stroke of 45 mm to a position corresponding to the displacement stroke of 5 mm, and flicker the first LED module 250 in a white color in S58.

The controller 100 operates the dishwasher 1 in a safety check mode while moving the handle 31 from a position corresponding to the displacement stroke of 45 mm to a position corresponding to the displacement stroke of 5 mm in S59. The controller 100 determines whether the hand of the person is sensed while the person is sensed based on the sensing signals of the first sensor 210 and the second sensor 220 in the safety check mode.

For example, the controller 100 may be configured to determine whether the hand is caught into between the handle 31 and the door 30 based on the signal sensed by the second sensor 220. Alternatively, the controller 100 may be configured to determine whether the object is caught into between the handle 31 and the door 30 based on a magnitude of the current according to the load of the handle driving motor 360.

In response to that the hand is caught into between the handle 31 and the door 30, the controller 100 operates the dishwasher 1 in a safety mode in S60. In the safety mode, the controller 100 may be configured to drive the handle driving motor 351 to move the handle 31 from a position corresponding to the displacement stroke of Xmm to a position corresponding to the displacement stroke of 45 mm, to flicker the first LED module 250 in a red color, and to drive the haptic motor 360 to generate the vibration.

When it is determined that the handle 31 is not caught into between the door and the handle in the safety check mode, the controller 100 operates the dishwasher 1 in a washing operation mode in S61.

The controller 100 may be configured to check whether a person is detected by the first sensor 210 and a human hand is detected by the second sensor 220 during the execution of the washing operation mode in S62.

When the human hand is sensed while operating in the washing operation mode the controller 100 operates the dishwasher 1 in a second pop-up mode in S63. In the second pop-up mode, the controller 100 may be configured to drive the handle driving motor 351 to extend the handle 31 by 45 mm in a frontward direction of the door 30.

In addition, when the human hand is sensed while operating in the washing operation mode, the controller 100 may be configured to change the color of the first LED module 250 based the temperature in the inside of the dishwasher 1 to notify the user of the temperature state thereof. For example, when the internal temperature of the dishwasher 1 is higher than or equal to a predetermined temperature, the first LED module 250 may be flashed in a red color so that the user may recognize this state.

This may refer to as a scenario in which when the user attempts to open the door 30 during the operation of the dishwasher 1, the controller 100 operates the handle 31 in the second pop-up mode and notifies the user of the inside temperature of the dishwasher 1.

Thereafter, the controller 100 performs the steps S56, S57, S58, S59, and S60, and operates the dishwasher 1 again in the washing operation mode in S61.

The controller 100 checks whether the human hand is detected during operation in the washing operation mode in S62 and determines whether the operation of the dishwasher 1 has been completed in S64. When the operation of the dishwasher 1 has been completed, the dishwasher 1 again operates in the first default mode.

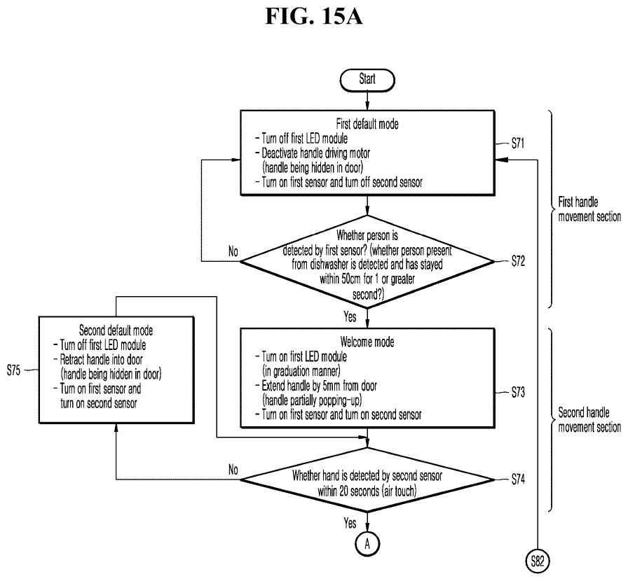

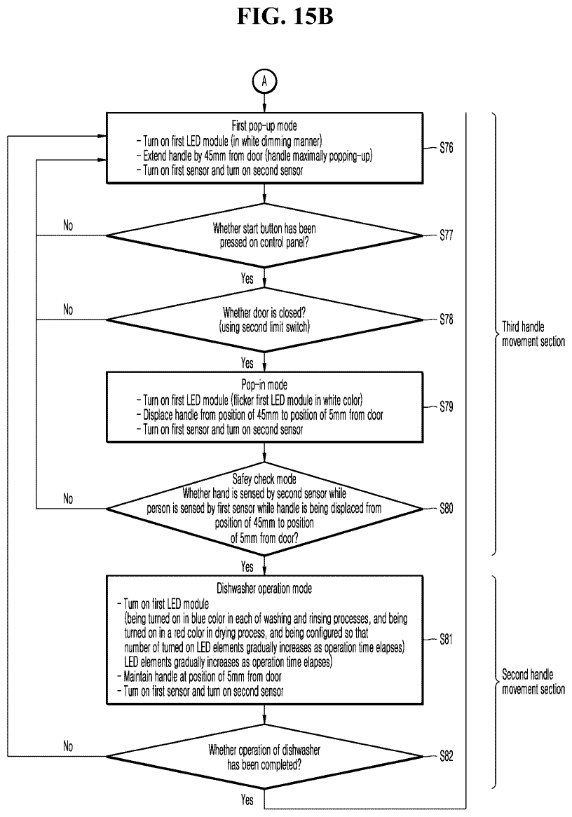

FIGS. 15A and 15B are a flowchart illustrating a method for controlling the dishwasher 1 according to still yet another embodiment of the present disclosure.

Referring to FIGS. 11, 15A and 15B, the controller 100 of the dishwasher 1 determines whether a person is detected by the first sensor 210 in a standby state S71 of the first default mode in S72.

When a person is sensed by the first sensor 210, the controller 100 drives the handle driving motor 351 to extend the handle 31 by 5 mm in a frontward direction from the door 30, turns on the first LED module 250 to act as the welcome lighting, and turns on the second sensor 220 in S73.

The controller 100 determines whether a human hand is sensed by the second sensor 220 disposed in the handle 31 in S74.

In this regard, when the human hand is not detected by the second sensor 220, the controller 100 operates the dishwasher 1 in a second default mode in S75. In the second default mode, the controller 100 turns off the first LED module 250, drives the handle driving motor 351 to retract the handle 31 into the door 30 to hide the handle 31 in the door 30, and maintains the first sensor 210 and the second sensor 220 in an on state. This may refer to a scenario in which the controller 100 operates the handle 31 in the second default mode over time while the user stands in front of the dishwasher 1 and performs other tasks such as cooking.

When the human hand is sensed by the second sensor 220, the controller 100 drives the handle driving motor 351 to extend the handle 31 by 45 mm in a frontward direction, and turns on the first LED module 250 in a white dimming manner in S76.

The controller 100 determines whether the start button has been activated on the control panel 32 in S77. When the start button has been activated on the control panel 32, the controller 100 determines whether the door 30 is opened or closed using the second limit switch 240 in S78.

Upon determination that the door 30 is closed, the controller 100 operates the handle 21 in a pop-in mode in S79. That is, the controller 100 drives the handle driving motor 351 to move the handle 31 from a position corresponding to the displacement stroke of 45 mm to a position corresponding to the displacement stroke of 5 mm, and flashes the first LED module 250 in a white color in S79.

The controller 100 may be configured to determine whether the hand is caught into between the handle 31 and the door 30 based on a signal of at least one of the sensors while moving the handle 31 from a position corresponding to the displacement stroke of 45 mm to a position corresponding to the displacement stroke of 5 mm in S80.

When the handle 31 is not caught into between the handle 31 and the door 30, the controller 100 operates the dishwasher 1 in the washing operation mode in S81 and determines whether the operation of the dishwasher 1 has been completed in S82. When the operation of the dishwasher 1 has been completed, the dishwasher 1 again operates in the first default mode.

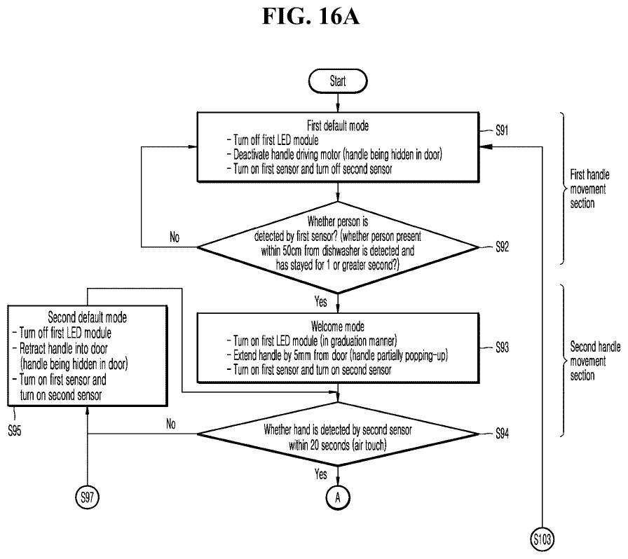

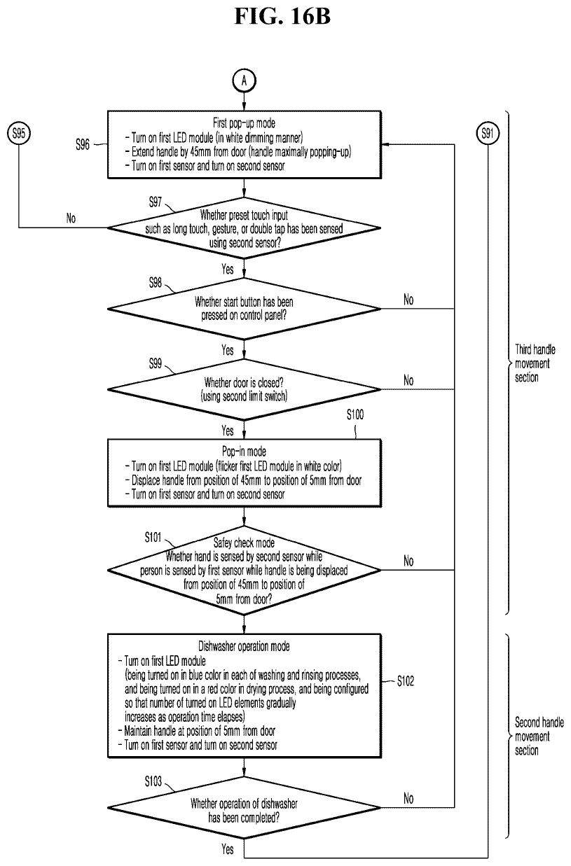

FIGS. 16A and 16B are a flowchart illustrating a method for controlling the dishwasher 1 according to still yet another embodiment of the present disclosure.

Referring to FIGS. 11, 16A and 16B, the controller 100 of the dishwasher 1 determines whether a person is sensed by the first sensor 210 in a standby state S91 of the first default mode in S92.

When the person is sensed by the first sensor 210, the controller 100 drives the handle driving motor 351 to extend the handle 31 by 5 mm in a frontward direction from the door 30, turns on the first LED module 250 to act as the welcome lighting, and turns on the second sensor 220 in S93.

The controller 100 determines whether a human hand is sensed by the second sensor 220 disposed in the handle 31 in S94.

In response to that the human hand is not detected by the second sensor 220, the controller 100 operates the dishwasher 1 in the second default mode in S95. In the second default mode, the first LED module 250 is turned off, the handle 31 is hidden in the door 30, and the first sensor 210 and the second sensor 220 are maintained in an on state.

When the human hand is sensed by the second sensor 220, the controller 100 drives the handle driving motor 351 to extend the handle 31 in a frontward direction by 45 mm, and turns on the first LED module 250 in a white dimming manner in S96.

The controller 100 checks whether a preset touch input has been sensed using the second sensor 220 in S97. For example, a long touch, a gesture, a double tap, etc. may be set as the preset touch input. The controller 100 may be configured to check whether the user inputs the long touch, the gesture, the double tap, etc. onto the handle 31 using the second sensor 220. This may refer to a scenario in which the controller 100 operates the handle 31 in the second default mode according to the user's will while the user stands in front of the dishwasher 1 and performs other works such as cooking.

In response to that the preset touch input is sensed by the second sensor 220, the controller 100 operates the dishwasher 1 in the second default mode in S95. In the second default mode, the controller 100 turns off the first LED module 250, hides the handle 31 inside the door 30, and maintains the first sensor 210 and the second sensor 220 in an on state.

In response to that the preset touch input has been detected by the second sensor 220, the controller 100 determines whether the start button has been activated on the control panel 32 in S98. When the start button has been activated on the control panel 32, the controller 100 determines whether the door 30 is opened or closed using the second limit switch 240 in S99.

In response to that the door 30 is closed, the controller 100 operates the handle 21 in the pop-in mode in S100. That is, the controller 100 drives the handle driving motor 351 to move the handle 31 from a position corresponding to the displacement stroke of 45 mm to a position corresponding to the displacement stroke of 5 mm, and flashes the first LED module 250 in the white color in S100. The controller 100 determines whether the hand is caught into between the handle 31 and the door 30 based on a signal of at least one of the sensors while moving the handle 31 from a position corresponding to the displacement stroke of 45 mm to a position corresponding to the displacement stroke of 5 mm in S101.

In response to that the hand is not caught into between the handle 31 and the door 30, the controller 100 operates the dishwasher 1 in the first pop-up mode in S96. In response to that the hand is not caught into between the handle 31 and the door 30, the controller 100 operates the dishwasher 1 in the washing operation mode.

The controller 100 operates the dishwasher 1 in the washing operation mode and then determines whether the washing operation has been completed in S103. When the operation of the dishwasher 1 has been completed, the controller 100 operates the dishwasher 1 in the first default mode. In the first default mode, the first LED module 250 is turned off, and the handle driving motor 351 moves the handle 31 by 0 mm, that is, is deactivated, and the controller 100 turns on the first sensor 210, and turns off the second sensor 220.

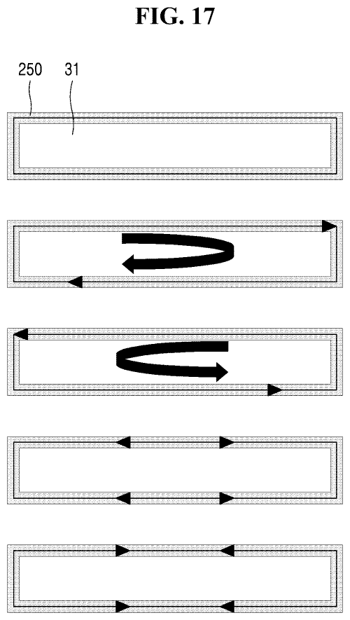

FIGS. 17 to 19 are diagrams illustrating lighting of a handle of a dishwasher according to some embodiments of the present disclosure.

Referring to FIG. 17, the first LED module 250 of the handle 31 may operate in the welcome mode in the second handle movement section. For example, the handle 31 may operate in the welcome mode in the state in which the handle 31 has been displaced in a frontward direction of the front panel 30a of the door 30 by 5 mm. In the welcome mode, the plurality of LED elements 3221 of the first LED module 250 of the handle 31 may be configured to be turned on in an animation manner, and to be sequentially turned on a clockwise/counterclockwise rotation manner, or a left/right directional gradation manner (be sequentially turned on from a center to each of the left and right sides, or from each of the left and right sides to the center), thereby acting as the preset welcome lighting. In one example, the first LED module 250 may be turned on in a white color in the welcome mode.

The operation setting of the first LED module 250 in the welcome mode may be controlled using the external terminal, for example, the remote controller or the smartphone. An application for setting the operation of the dishwasher 1 may be installed in the smartphone. The dishwasher 1 may transmit and receive data to and from the remote controller or the smart phone through the communication unit 60.

In addition, the first LED module 250 of the handle 31 may be configured to emit light such that the color of the light varies according to a washing, rinsing, or drying operation in the second washing operation mode in the second handle movement section. For example, the first LED module 250 of the handle 31 may be turned on in a blue color during each of the washing and rinsing cycles, may be turned on in a red color during the drying cycle, and may be turn on in a white color when all the cycles have been completed.

In addition, the first LED module 250 of the handle 31 may be turned on in different colors in various situations, such as a night dry situation, a steam situation, a high interior temperature situation, and the like. As described above, the dishwasher 1 may visually present the current situation based on the lighting color of the first LED module 250 of the handle 31 in the operation mode thereof.

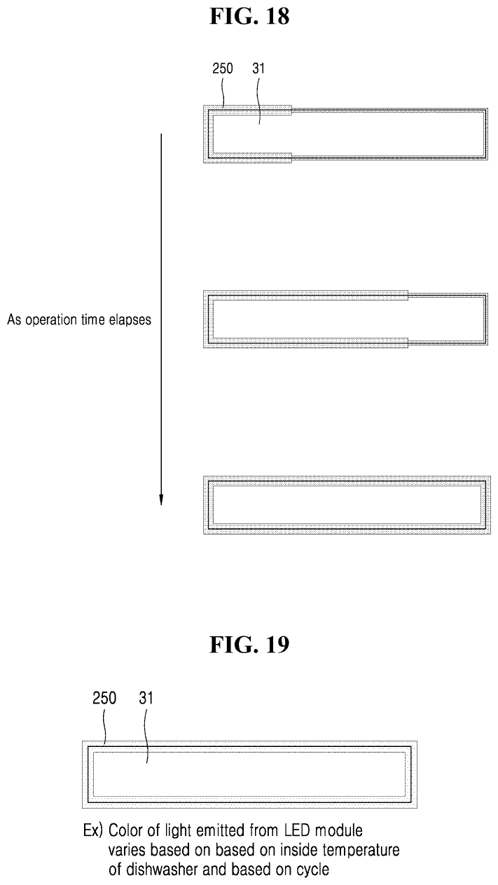

In addition, referring to FIG. 18, in the second handle movement section, the plurality of LED elements 3221 of the first LED module 250 of the handle 31 may be configured such that the number of turned on LED elements 3221 arranged in the left-right direction gradually increases according to the elapsed time duration of the washing, rinsing, or drying process and thus may be used as a lighting indicating the elapsed time duration.

In addition, the first LED module 250 of the handle 31 may be turned on in a red color when the human hand is detected to be caught into between the handle and the door while the handle is moving from the third handle movement section to the second handle movement section. For example, when it is sensed that the hand is caught into therebetween while moving from a position corresponding to the displacement stroke of 45 mm to a position corresponding to the displacement stroke of 5 mm, the first LED module 250 may be turned on in the red color, the haptic motor 360 of the handle 31 may generate the vibration, and the speaker 140 may generate the warning sound to notify the hand pinching.

In addition, in response to that the temperature of the inside of the dishwasher 1 is higher than a reference value when the user intends to open the door 30 during the operation of the dishwasher 1, the first LED module 250 of the handle 31 may be turned on in a red color. In response to that the temperature of the inside of the dishwasher 1 is lower than the reference value when the user intends to open the door 30 during the operation of the dishwasher 1, the first LED module 250 of the handle 31 may be turned on in a blue color.

A dishwasher according to an embodiment of the present disclosure may include a tub having a washing space defined therein and configured to accommodate therein a dish; a door configured to open or close the washing space of the tub; and a handle movably disposed in the door and configured to extend outwardly from the door or retract into the door, wherein the handle is configured to extend outwardly from the door to a first position or a second position, wherein a distance between the second position and the door is greater than a distance between the first position and the door.

A dishwasher according to an embodiment of the present disclosure may include: a door configured to open or close a washing space; a handle having a light source module disposed therein, wherein the handle is configured to retract into the door or extend from the door; a first sensor configured to sense an object present within a first distance from the dishwasher; a second sensor disposed inside the handle and configured to sense an object present within a second distance from the dishwasher, wherein the second distance is smaller than the first distance; a handle driving motor configured to move the handle in a frontward or rearward direction of a front surface of the door; and a controller configured to control the handle driving motor to extend the handle from the front surface of the door to a first position or a second position, based on a sensing signal of each of the first sensor and the second sensor, wherein a distance between the second position and the door is greater than a distance between the first position and the door.

Although the embodiments of the present disclosure have been described above in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A dishwasher comprising:
a tub having a washing space defined therein and configured to accommodate therein a dish;
a door configured to open or close the washing space of the tub; and
a handle movably disposed in the door and configured to extend outwardly from the door or retract into the door,
wherein the handle is configured to extend outwardly from the door to a first position or a second position, wherein a distance between the second position and the door is greater than a distance between the first position and the door.

2. The dishwasher of claim 1, wherein in response to that a person has been detected as approaching the dishwasher, the handle is configured to extend to the first position,
wherein in response to that a human hand has been detected, the handle is configured to extend to the second position.

3. The dishwasher of claim 1, wherein the dishwasher further comprises:
a first sensor configured to sense a person present within a first distance from the dishwasher;
a second sensor configured to sense a human hand present within a second distance from the dishwasher, wherein the second distance is smaller than the first distance;
a handle driving motor configured to reciprocate the handle in a frontward or rearward direction of the door; and
a controller configured to control the handle driving motor based on a detection signal of each of the first sensor and the second sensor.

4. The dishwasher of claim 3, wherein the first sensor is disposed on a lower side of the door, and the second sensor is disposed inside the handle.

5. The dishwasher of claim 3, wherein in response to that the person has been detected by the first sensor, the controller is configured to drive the handle driving motor to extend the handle to the first position.

6. The dishwasher of claim 5, wherein a light source module and a light guide for diffusing light emitted from the light source module to an outside of the dishwasher are disposed inside the handle,
wherein the first position is spaced from the door by a distance by which the handle has extended outwardly from the door such that the light guide is exposed to a user.

7. The dishwasher of claim 5, wherein in response to that the person has been sensed by the first sensor, the controller is configured to activate a sensing function of the second sensor to sense an object present within the second distance from the dishwasher,
wherein in response to that the human hand has been sensed by the second sensor the controller is configured to drive the handle driving motor to displace the handle from the first position to the second position,
wherein the second position is spaced from the door by a distance by which the handle has extended outwardly from the door such that the handle is able to be gripped by a user.

8. The dishwasher of claim 3, wherein the handle includes:
a handle body configured to be movable in a frontward or backward direction from a front surface of the door;
a printed circuit board disposed inside the handle body and having a light source module including a plurality of light source elements mounted thereon;
a light guide disposed on one side of the printed circuit board and configured to diffuse light emitted from the plurality of light source elements;
a gasket mounted on the printed circuit board; and
a touch electrode mounted on the printed circuit board and included in the second sensor.

9. The dishwasher of claim 8, wherein the plurality of light source elements are arranged along a periphery of the handle.

10. The dishwasher of claim 8 wherein the gasket includes a plurality of gaskets arranged on the printed circuit board,
wherein the touch electrode includes one electrode plate connected to the plurality of gaskets or includes a plurality of electrode plates individually and respectively connected to the plurality of gaskets.

11. The dishwasher of claim 8, wherein the controller is further configured to:
apply a touch driving signal to the touch electrode;
receive a feedback signal from the touch electrode in response to the touch driving signal, wherein the feedback signal changes in accordance with proximity of the human hand to the touch electrode;
determine whether the human hand is in proximity to the handle based on the feedback signal; and
perform a preset user interface (UI) function based on a touch position on the handle by the human hand or a touch pattern by the human hand.

12. The dishwasher of claim 8, wherein in response to that the handle has extended to the first position, a side surface of the light guide is exposed to an outside of the handle and the light guide diffuses light emitted from the plurality of light source elements along a periphery of the handle.

13. The dishwasher of claim 1, wherein the handle has a default position at which the handle has retracted into the door.

14. A dishwasher comprising:
a door configured to open or close a washing space;
a handle having a light source module disposed therein, wherein the handle is configured to retract into the door or extend from the door;
a first sensor configured to sense an object present within a first distance from the dishwasher;
a second sensor disposed inside the handle and configured to sense an object present within a second distance from the dishwasher, wherein the second distance is smaller than the first distance;
a handle driving motor configured to move the handle in a frontward or rearward direction of a front surface of the door; and
a controller configured to control the handle driving motor to extend the handle from the front surface of the door to a first position or a second position, based on a sensing signal of each of the first sensor and the second sensor, wherein a distance between the second position and the door is greater than a distance between the first position and the door.

15. The dishwasher of claim 14, wherein in response to that the object has been sensed by the first sensor, the controller is configured to control the handle driving motor to extend the handle to the first position at which light emitted from the light source module is exposed to an outside.

16. The dishwasher of claim 15, wherein in response to that the object has been sensed by the first sensor, the controller is configured to activate a sensing function of the second sensor to detect the object present within the second distance and to operate the light source module.

17. The dishwasher of claim 15, wherein in response to that the object present within the second distance is sensed by the second sensor in a state in which the object present within the first distance has been sensed by the first sensor, the controller is configured to control the handle driving motor to displace the handle from the first position to the second position.

18. The dishwasher of claim 14, wherein in response to that a start button has been activated on a control panel and the door has been closed, the controller is configured to control the handle driving motor to displace the handle from the second position to the first position.

19. The dishwasher of claim 16, wherein in response that the object is sensed by the second sensor while the handle is moving from the second position to the first position, the controller is configured to control the handle driving motor to displace the handle from the second position to the first position.

20. The dishwasher of claim 19, wherein in response that the object is sensed by the second sensor while the handle is moving from the second position to the first position, the controller is configured to operate the light source module, a haptic motor, or a speaker to notify a user of the object being sensed in a visual, auditory, or tactile manner.

21. The dishwasher of claim 14, wherein in response to that a start button has been activated on a control panel and the door has been closed, the controller is configured to control the handle driving motor to displace the handle from the second position to the first position and then to operate the dishwasher.

22. The dishwasher of claim 14, wherein in response to that the object is sensed by the second sensor within a predetermined time duration after a time point at which the object is sensed by the first sensor during an operation of the dishwasher, the controller is configured to control the handle driving motor to displace the handle from the first position to the second position.

23. The dishwasher of claim 22, wherein in response to that the object is sensed by the second sensor in a state in which the object is sensed by the first sensor during the operation of the dishwasher, the controller is configured to turn on the light source module in a color varying based on an inside temperature of the dishwasher.

24. The dishwasher of claim 14, wherein in response to that the object is sensed by the first sensor in a first default mode, the controller is configured to operate the handle in a welcome mode,
wherein in the welcome mode, the controller is configured to control the handle driving motor to displace the handle inserted into the door to the first position, turn on the light source module, and activate the second sensor to detect the object.

25. The dishwasher of claim 24, wherein in response to that the object is not sensed by the second sensor within a predetermined time duration after the object is sensed by the first sensor in the welcome mode, the controller is configured to operate the handle in a second default mode,
wherein in the second default mode, the controller is configured to control the handle driving motor to retract the handle into the door, turn off the light source module, and maintain a sensing function of each of the first sensor and the second sensor in an active state.

26. The dishwasher of claim 24, wherein in response to that the object is sensed by the second sensor within a predetermined time duration after the object is sensed by the first sensor in the welcome mode, the controller is configured to operate the handle in a first pop-up mode,
wherein in the first pop-up mode, the controller is configured to control the handle driving motor to displace the handle to the second position, turn on the light source module, and maintain a sensing function of each of the first sensor and the second sensor in an active state.

27. The dishwasher of claim 26, wherein in response to that a preset touch input is sensed by the second sensor in the first pop-up mode, the controller is configured to control the handle driving motor to retract the handle into the door, turn off the light source module, and maintain a sensing function of each of the first sensor and the second sensor in an active state.

28. The dishwasher of claim 26, wherein in response to that a start button instructing start of dishwashing has been activated and a closed state of the door has been sensed in the first pop-up mode, the controller is configured to operate the handle in a pop-in mode,
wherein in the pop-in mode, the controller is configured to control the handle driving motor to displace the handle from the second position to the first position, and turn on the light source module.

29. The dishwasher of claim 28, wherein in response to that the object is detected by the second sensor while the handle is operating the pop-in mode, the controller is configured to operate the handle in a safety mode,
wherein in the safety mode, the controller is configured to control the handle driving motor to displace the handle to the second position, and turn on the light source module, a haptic motor, or a speaker to notify the user of the object being detected in a visual, auditory, or tactile manner.

30. The dishwasher of claim 26, wherein in response to that a start button instructing start of dishwashing has been activated and a closed state of the door has been sensed in the first pop-up mode, the controller is configured to operate the dishwasher in a dishwasher operation mode,
wherein in the dishwasher operation mode, the controller is configured to control the handle driving motor to displace the handle to the first position, turn on the light source module in a color varying based on a cycle situation of the dishwasher operation mode, and maintain a sensing function of each of the first sensor and the second sensor in an active state.

31. The dishwasher of claim 30, wherein in response to that the object is detected by the first sensor and then, the object present within the second distance is detected by the second sensor within a predetermined time duration after detecting the object by the first sensor in the dishwasher operation mode, the controller is configured to operate the handle in a second pop-up mode,
wherein in the second pop-up mode, the controller is configured to control the handle driving motor to displace the handle from the first position to the second position, and turn on the light source module in a color corresponding to an inside temperature of the dishwasher.
